(19) United States
(12) Patent Application Publication
(10) Pub. No.: US 2025/0010563 A1
(43) Pub. Date: Jan. 9, 2025

(54) MANUFACTURING SYSTEMS FOR APPLYING MATERIALS TO ARTICLES OF APPAREL AND METHODS OF USING THE SAME

(71) Applicant: NIKE, Inc., Beaverton, OR (US)

(72) Inventor: Tory Cross, Portland, OR (US)

(73) Assignee: NIKE, Inc., Beaverton, OR (US)

(21) Appl. No.: 18/896,672

(22) Filed: Sep. 25, 2024

Related U.S. Application Data
(62) Division of application No. 17/028,948, filed on Sep. 22, 2020.
(60) Provisional application No. 62/904,575, filed on Sep. 23, 2019.

(51) Int. Cl. B29D 35/00; A43D 25/20; B25J 11/00; B25J 15/00; B25J 15/06; B29D 35/06

(52) U.S. Cl. CPC B29D 35/00; A43D 25/20; B25J 11/00; B25J 15/0023; B25J 15/0616; B29D 35/0072; B29D 35/067; A43D 2200/10; A43D 2200/60

(57) ABSTRACT

A lifting system for post frame construction comprises a winch system coupled to a frame, a first bracket configured to be secured to a portion of a roof framing system, and a pulley system comprising at least two pulley wheels mounted on a second bracket. The frame is configured to be secured to a lower portion of a column of a building structure and the second bracket is configured to be secured to a top of the column.

### CROSS REFERENCE TO RELATED APPLICATIONS

This application is a divisional of U.S. patent application Ser. No. 17/028,948, filed on Sep. 22, 2020, which claims the benefit of U.S. Provisional Application No. 62/904,575, filed Sep. 23, 2019. The prior applications are incorporated herein by reference in their entirety.

### FIELD

This disclosure relates generally to manufacturing systems, including systems and methods for applying materials to articles, such as articles of apparel.

### BACKGROUND

The manufacturing of materials for use in various consumer products, such as apparel, can be labor intensive and time consuming. For example, conventional methods and systems for constructing articles of footwear on a last can include the manual application of components to a lasted upper. Manual application of such components to the lasted upper can be inefficient and also result in the inaccurate placement of materials.

### BRIEF DESCRIPTION OF THE DRAWINGS

FIG. 1 illustrates an exemplary system for receiving an article of apparel and applying secondary components to the article of apparel.

FIG. 2 illustrates another view of the system of FIG. 1, with the article of apparel in contact with a secondary component.

FIG. 3 illustrates another view of the system of FIG. 1, with the secondary component applied to the article of apparel.

FIGS. 4A and 4B illustrate an embodiment in which the secondary components applied to the article of apparel include a sole structure.

FIGS. 5A and 5B illustrate an embodiment in which the secondary components applied to the article of apparel include a material that wraps around at least a portion of the article of apparel.

FIGS. 6A and 6B illustrate an embodiment in which the secondary components applied to the article of apparel include a heel member and a toe member.

FIGS. 7A and 7B illustrate additional exemplary embodiments of secondary components applied to an article of apparel.

FIG. 8 illustrates an exemplary system for preparing and delivering secondary components to a receiving station for application to an article of apparel.

FIG. 9 illustrates another view of the system of FIG. 8, with a secondary component being received by a material delivery system for delivery to a receiving station.

FIG. 10 illustrates another view of the system of FIG. 8, with a secondary component positioned at a receiving station for application to an article of apparel.

FIG. 11 illustrates another exemplary system for preparing and delivering secondary components to a receiving station for application to an article of apparel.

FIGS. 12A-12C illustrate exemplary receiving stations for receiving secondary components for application to articles of apparel.

FIGS. 13A and 13B illustrate an exemplary receiving station for receiving and securing secondary components for application to articles of apparel.

FIGS. 14A-14D illustrate an exemplary system for applying heat and/or radiation to a secondary component and moving an article of apparel into position to apply the secondary component to the article of apparel.

FIG. 15A-15F depicts an exemplary system being used to apply a plurality of secondary components to an article.

FIG. 16 illustrates a schematic view of an embodiment that includes a computing system.

FIG. 17 depicts an exemplary flow chart outlining an exemplary method for applying a secondary component to an article.

FIG. 18 depicts an exemplary computing system for implementing the disclosed technology.

FIG. 19 depicts an exemplary article of apparel mounted on a support of a multi-axis robot.

FIG. 20 depicts an exemplary article of apparel mounted on a support of a multi-axis robot.

FIG. 21 depicts an exemplary article of apparel mounted on a support of a multi-axis robot.

FIG. 22 illustrates an embodiment in which a secondary component is printed on a surface of a receiving station.

FIG. 23 illustrates another embodiment in which a secondary component is printed on a surface of a receiving station.

FIGS. 24A and 24B illustrate an embodiment in which the secondary component applied to the article of apparel includes a sole structure that is printed onto the receiving station.

FIGS. 25A and 25B illustrate an embodiment in which the secondary component applied to the article of apparel include a layer of ink printed onto the receiving station.

FIG. 26 illustrates an embodiment in which a bonding material is printed onto a surface of a secondary component.

### DETAILED DESCRIPTION

Disclosed herein are various embodiments of manufacturing systems and methods relating to the construction of articles of apparel and similar products.

In one embodiment, a manufacturing system is provided for applying one or more secondary components to an article of apparel. The system includes a first multi-axis robot comprising an arm and a support structure coupled to the arm, one or more receiving stations positioned adjacent to the multi-axis robot, and one or more image devices arranged to capture image information from an area of the one or more receiving stations to identify a position and orientation of the one or more secondary components when received on the one or more receiving stations. The support structure can be sized to receive a first component of the article of apparel secured thereon and the one or more receiving stations can comprise an upper surface within an operational reach of the arm of the first multi-axis robot and sized to receive the one or more secondary components.

In another embodiment, a method of manufacturing an article of apparel can comprise securing a first component to a support structure coupled to an arm of a first multi-axis robot, the first component forming at least a portion of the article of apparel and having an external surface; disposing a second component on a surface of a receiving station, the second component comprising a material that has an upper surface and a lower surface, the lower surface facing the surface of the receiving station; attaching the upper surface of the second component to the external surface of the first component by moving the arm of the multi-axis robot from a first position in which the first component is spaced apart from the second component to a second position in which the external surface of the first component is in contact with the upper surface of the second component; and moving the first component away from the receiving station with the second component attached to the external surface of the first component.

In another embodiment, a support structure can be provided for receiving and gripping a secondary component thereon. The structure can include a flexible housing that defines an internal volume and has an upper surface for receiving the secondary component, and a vacuum device coupled to the flexible housing and configured to reduce an internal pressure of the flexible housing. The flexible housing can be movable between a non-collapsed state and a collapsed state, and when the internal pressure of the flexible housing is reduced, the flexible housing can transition from the non-collapsed state to the collapsed state in which the flexible housing is at least partially collapsed. The upper surface of the flexible housing transitions from a flexible surface in the non-collapsed state to a rigid surface in the collapsed state.

In yet another embodiment, a method of securing an attachment component in a fixed position for application to an article of apparel is provided. The method includes disposing the attachment component on a surface of a support structure, the support structure comprising a flexible housing with an internal volume and an upper surface; and applying a vacuum to the flexible housing to reduce an internal pressure of the flexible housing and at least partially collapse the flexible housing. The attachment component can comprise a material that has an upper surface, a lower surface, and a side surface, the lower surface facing the surface of the support structure, and when the vacuum is applied, the flexible housing can collapse around the attachment component to restrict relative movement between the surface of the support structure and lower surface of the attachment component by causing the flexible housing to contact the side surface of the attachment component.

Additional embodiments and details of the various implementations of the above embodiments are provided herein in the following specification and claims.

### GENERAL CONSIDERATIONS

The detailed descriptions herein describe certain exemplary embodiments relating to the manufacture of footwear; however, it should be understood that the various systems and methods disclosed herein can be applied to other manufacturing systems, including manufacturing systems related to articles of apparel other than footwear. In addition, although the exemplary embodiments may disclose particular types of footwear it should be understood that other types of footwear may benefit from the disclosed systems and methods. For example, embodiments can be adapted for footwear for any activity, including any sport and/or recreational activity such as walking, jogging, running, hiking, tennis and other racquet sports, handball, training, as well as team sports such as basketball, volleyball, lacrosse, field hockey, and soccer.

As used herein, the term “article of apparel” refers to any apparel, clothing, and/or equipment that can be worn, including articles of footwear, as well as hats, caps, shirts, jerseys, jackets, socks, shorts, pants, undergarments, athletic support garments, gloves, wrist/arm bands, sleeves, headbands, backpacks, shin guards, and the like.

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved. Headings are provided solely for purposes of readability and it should be understood that elements and/or steps in one section can be combined with elements and/or steps under different headings in this disclosure.

As used in this application the singular forms “a,” “an,” and “the” include the plural forms unless the context clearly dictates otherwise. Additionally, the term “includes” means “comprises.” Furthermore, as used herein, the term “and/or” means any one item or combination of items in the phrase. In addition, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For purposes of this disclosure, portions of an article of footwear (and the various component parts thereof) may be identified based on regions of the foot located at or near that portion of the article of footwear when the footwear is worn on the properly sized foot. For example, an article of footwear and/or a sole structure may be considered as having a “forefoot region” at the front of the foot, a “midfoot” region at the middle or arch area of the foot, and a “heel region” at the rear of the foot. Footwear and/or sole structures also include a “lateral side” (the “outside” or “little toe side” of the foot) and a “medial side” (the “inside” or “big toe side” of the foot). The forefoot region generally includes portions of the footwear corresponding to the toes and the joints connecting the metatarsals with the phalanges. The midfoot region generally includes portions of the footwear corresponding with the arch area of the foot. The heel region generally corresponds with the rear portions of the foot, including the calcaneus bone. The lateral and medial sides of the footwear extend through the forefoot, midfoot, and heel regions and generally correspond with opposite sides of the footwear (and may be considered as being separated by a central longitudinal axis). These regions and sides are not intended to demarcate precise areas of footwear. Rather, the terms “forefoot region,” “midfoot region,” “heel region,” “lateral side,” and “medial side” are intended to represent general areas of an article of footwear and the various components thereof to aid the in discussion that follows.

### EXEMPLARY SYSTEMS FOR APPLYING SECONDARY COMPONENTS TO ARTICLES

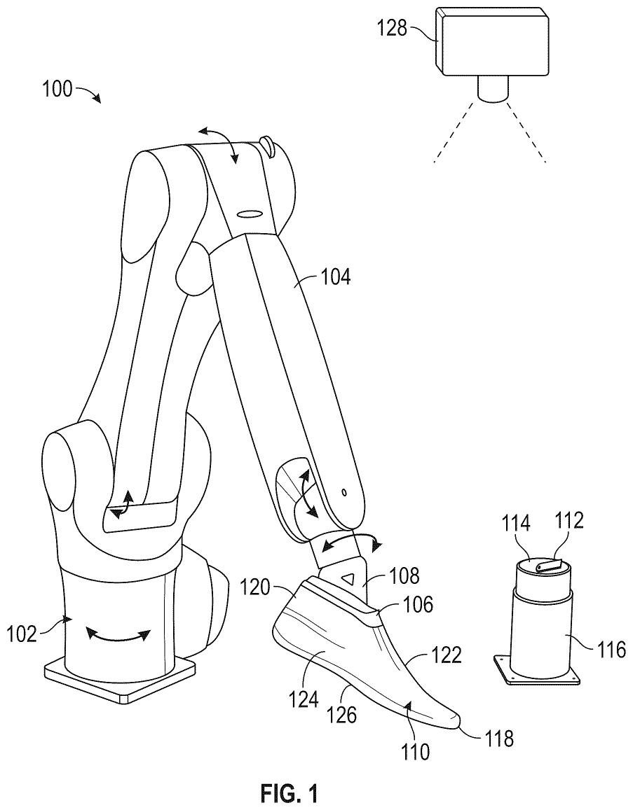

FIGS. 1-3 depict an exemplary system 100 that includes a multi-axis robot 102 with an arm 104 coupled to an article supporting member. As shown in FIG. 1, the article supporting member can be a last 106 that is coupled to the arm 104 through a last extension 108. Although the exemplary embodiments that follow illustrate systems and methods of manufacturing articles of footwear (or components thereof) supported on the last 106, it should be understood that the disclosed systems and methods can apply secondary components to any article that can be supported on a structure coupled to the arm of a multi-axis robot.

As used herein, the term “last” refers to a tool form about which an article of footwear can be constructed. The last may define, at least in part, the contours, shape, style, and other characteristics of a resulting article of footwear. Lasted component 110 can be any component of an article of footwear that can be received on the last 106. For example, as shown in FIG. 1, the lasted component 110 can be an upper with an interior volume in which the last 106 is at least partly received.

The lasted component 110 can be formed from a variety of materials, such as leather, knit, woven, braided, felted, non-woven, and the like. Some or all of the lasted component 110 can be formed using the methods described herein. Alternatively, and/or in addition to the methods described herein, at least some portions of the lasted component 110 can be formed using conventional methods before, or after, being secured to the last 106 (e.g., methods that do not require moving the lasted component into contact with secondary materials). Using the methods described herein, or a combination of these methods and conventional methods, the lasted component can be made from a single material or a variety of materials, and can be formed from continuous material, a discontinuous material, a cut-and-sew combination, a cut-and-adhere combination, fused layers, and the like. Therefore, it is contemplated herein that the lasted component may be formed from a variety of materials and/or from a combination of the disclosed methods with conventional methods.

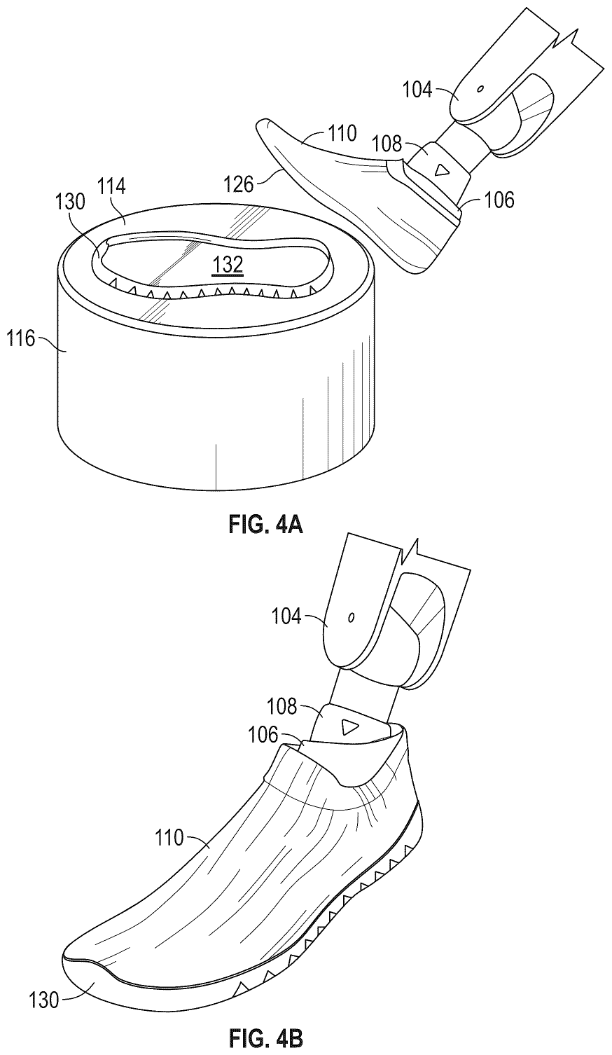

In some embodiments, the lasted component can have a bottom portion that completely or partially encloses the bottom (i.e., underside) of the last 106. The bottom portion can be formed from the same or different materials from the rest of the lasted component and/or can be continuous or discontinuous with the other portions of the lasted component. In some embodiments, a sole structure can be coupled (e.g., adhered, stitched) to the lasted component either before or after being received on the last 106. FIGS. 4A-4B, discussed below, illustrate an embodiment of a sole structure that is coupled to the lasted component using the methods described herein.

The exemplary embodiment of FIGS. 1-3 illustrates the last 106 inserted into an internal volume formed by a lasted component 110 that has a unitary knit construction. The lasted component 110 has a toe end 118, an opposite heel end 120, a medial side 122, and an opposite lateral side 124. In addition, lasted component 110 has a bottom portion (lower surface) 126. Lasted component 110 can have different types of knit patterns. For example, some areas can have a tighter weave to give the foot more support while others have different weaves to provide greater flexibility and/or breathability.

Although the lasted component 110 of FIGS. 1-3 is illustrated as a unitary knit construction that has a “sock”—like constructions, the lasted component can be of any configuration and include any number of components not specifically depicted in the figures hereof. For example, it is contemplated that the lasted component 110 can (but not necessarily) comprise a tongue, a forefoot opening, an ankle collar, a lacing system, one or more apertures, a toe box, a heel counter, and the like.

Referring to FIGS. 1-3, the multi-axis robot 102 is configured to move the lasted component 110 in a three-dimensional workspace with a high degree of accuracy. Preferably, the multi-axis robot 102 can move in at least five axes (a 5-DOF robot), which allows the lasted component 110 to move through the three spatial axes (X-Y-Z) and at least two further axes. In some embodiments, the multi-axis robot can move in all six axes (a 6-DOF robot). FIGS. 1-3 illustrates a 5-DOF robot with motors that permit movement in the directions indicated in FIG. 1.

One or more machine vision sensors, such as one or more imaging devices 128, can be provided to facilitate robot guidance, identify the location and orientation of the secondary components and other system elements, and/or provide other relevant information for achieving highly accurate application of secondary components 112 to the lasted component 110.

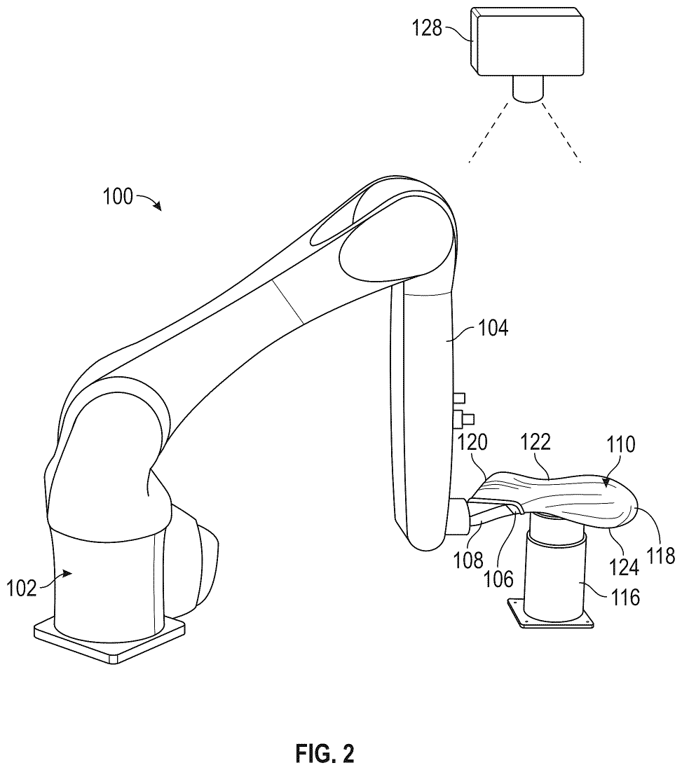

FIG. 1 illustrates the lasted component 110 positioned on last 106 in a first position. As shown in FIG. 2, after the location and orientation of the secondary component 112 is identified/confirmed, robot 102 is directed to move the lasted component 110 into a desired position to engage with the secondary component 112. The secondary components 112 can be received on any suitable surface for application in the manner described herein. For example, FIGS. 1-3 show a secondary component 112 on a surface 114 of a receiving station 116.

In some embodiments, the secondary component 112 can have a bonding material on an upper surface (e.g., an exposed surface) to facilitate bonding between an external surface of the lasted component and an upper surface of the secondary component upon contact. Bonding includes bonding through use of glue or other adhesives, through melting and subsequent solidification of a bonding material, and/or through melting and subsequent solidification of a substituent element, but excludes stitching, stapling or similar types of mechanical attachment to structurally connect the substituent elements of the bonded composite.

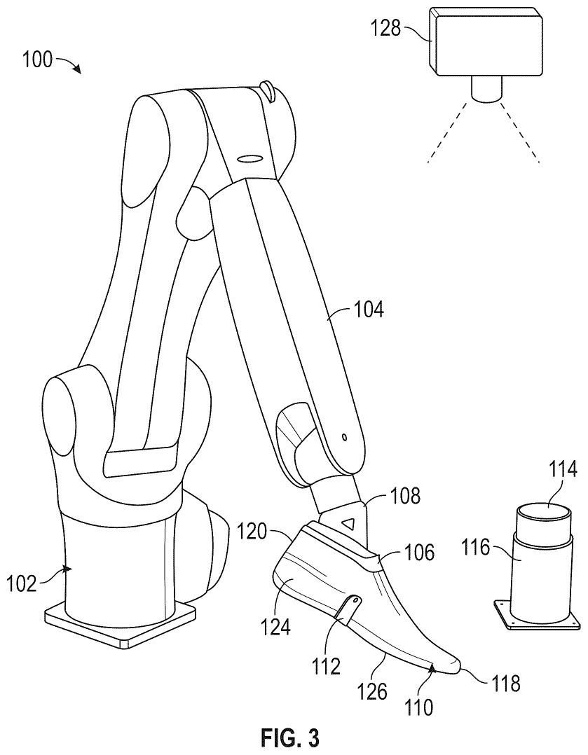

The lasted component 110 can come into contact with the entire surface of the secondary component 112 at the same time or, if desired, the lasted component 110 can contact a first portion of the secondary component 112 and then, slowly or quickly (e.g., depending on the selected secondary components and/or bonding material, and/or other design requirements), move into contact with other portions of the secondary component to facilitate bonding and/or attachment in stages. The lasted component 110 can remain in contact with the secondary component 112 as long as necessary to ensure sufficient bonding between the lasted component 110 and secondary component 112 before moving to a different portion of the secondary component or before moving away from the surface 114 of the receiving station 116 (FIG. 3).

### EXEMPLARY SECONDARY COMPONENTS AND METHODS OF APPLICATION TO AN ARTICLE

FIGS. 1-3 illustrate the application of a secondary component 112 to a mid-foot portion of the lasted component 110. The secondary component 112, after application to the lasted component, extends from a lower area of the midfoot to an upper area of the midfoot. The secondary component can comprise any suitable material for providing a structural and/or aesthetic benefit to the article of footwear. FIGS. 4-6 illustrate other exemplary lasted components 110 that have received secondary components which were applied in the same general manner as the secondary component 112 shown in FIGS. 1-3.

The secondary components described herein can include materials of any shape, form, and structure, and can be applied to achieve various functional and/or aesthetic improvements. For example, the secondary components that are to be applied to the lasted component can be selectively applied to locations on the lasted component to provide improved flexibility, durability, shaping, breathability, etc. Materials that can form secondary components include textiles, natural fabrics, synthetic fabrics, knits, woven materials, nonwoven materials, meshes, leathers, synthetic leathers, polymers, rubbers, and foams. In addition, any other material not listed above may be suitable for application in the manners described herein, so long as the material is capable of being bonded to a surface of the lasted component or capable of being bonded to a surface of another material that has been bonded to or otherwise attached to the lasted component.

FIG. 4A illustrates a sole structure 130 disposed on a surface 114 of a receiving station 116 for application to the lasted component 110. Lasted component 110 can move into contact with the sole structure 130, either all at once (e.g., directly from above) or through initial contact with a first portion (e.g., a heel region) and then subsequent contact with other portions (e.g., the midfoot and toe region).

A bonding material (e.g., an adhesive) can be provided on an upper surface 132 of the sole structure 130 to bond a lower surface 126 of the lasted component 110 to the upper surface 132 of the sole structure 130. The sole structure 130 can be any structure that provides support for a wearer's foot and bears the surface that is in direct contact with the ground or playing surface, such as a single sole, a combination of an outsole and an inner sole, a combination of an outsole, a midsole and an inner sole, and a combination of an outer covering, an outsole, a midsole and an inner sole. FIG. 4B illustrates the sole structure 130 after it is bonded to the lower surface 126 of the lasted component 110.

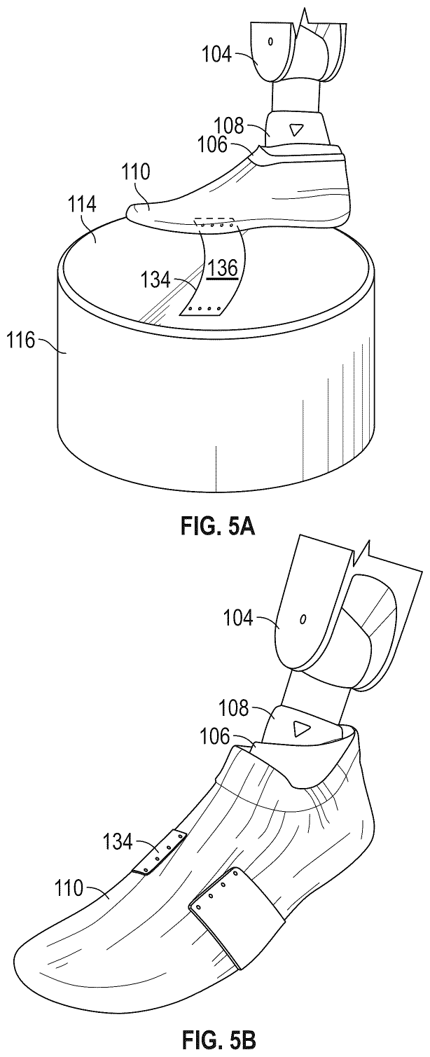

FIG. 5A illustrates a midfoot wrap 134 disposed on the surface 114 of the receiving station 116 for application to the lasted component 110. Midfoot wrap 134 can be sized to extend completely, or nearly completely, around a midfoot region of the lasted component 110. Midfoot wrap 134 can be formed from various materials, such as stretchy polymer or a polymer and textile composite. Midfoot wrap 134 can comprise, for example, stretchable PU coated synthetics and textiles, or non-woven elastomeric polymer-based materials. In some embodiments, the receiving station 116 can comprise a structure, such as clamps, for retaining the midfoot wrap 134 in an elongated (i.e., stretched) configuration.

Lasted component 110 is shown in FIG. 5A initiating contact with a first portion of the midfoot wrap 134. A bonding material (e.g., an adhesive) on an upper surface 136 of the midfoot wrap 134 bonds to surfaces of the lasted component 110 to secure the midfoot wrap 134 to the lasted component 110. FIG. 5B illustrates the midfoot wrap 134 after it has been bonded to surfaces that completely or substantially surround the midfoot region of the lasted component 110. During application of the midfoot wrap to the lasted component, the lasted component can move (e.g., rotate) so that the midfoot wrap sequentially engages with different portions of the lasted component for bonding.

Although illustrated as extending around the midfoot region of lasted component 110, a wrap can be provided at any region of the lasted component 110, including for example, in the forefoot region and/or around a rear of the lasted component 110 (e.g., above the heel and below the ankle).

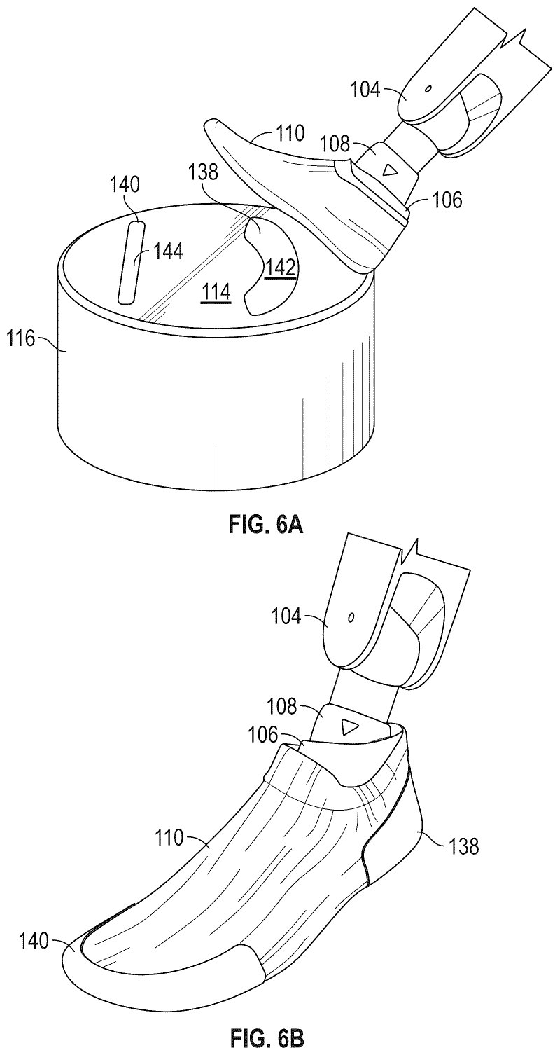

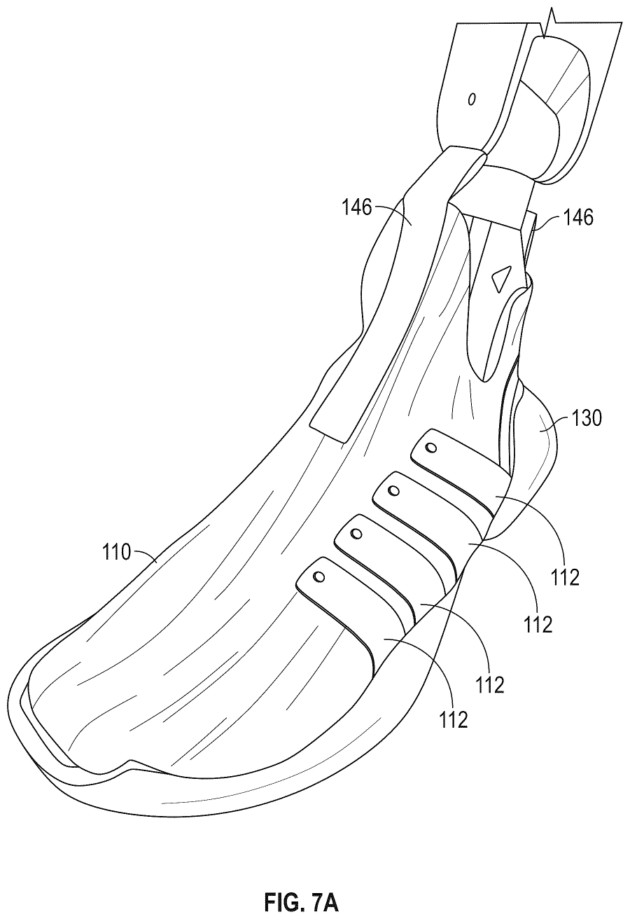

FIG. 6A illustrates a heel member 138 and a toe member 140 disposed on a surface 114 of a receiving station 116 for application to the lasted component 110. As in other embodiments, lasted component 110 can move into contact with these secondary components, either all at once or through initial contact with a first portion and then subsequent contact with other portions.

A bonding material (e.g., an adhesive) can be provided on an upper surface 142 of the heel member 138 and on an upper surface 144 of the toe member 140 to bond a surface of the lasted component 110 to the upper surfaces 142, 144 of the heel members 138 and toe member 140. FIG. 6B illustrates the heel member 138 and toe member 140 after they are bonded to the lasted component 110.

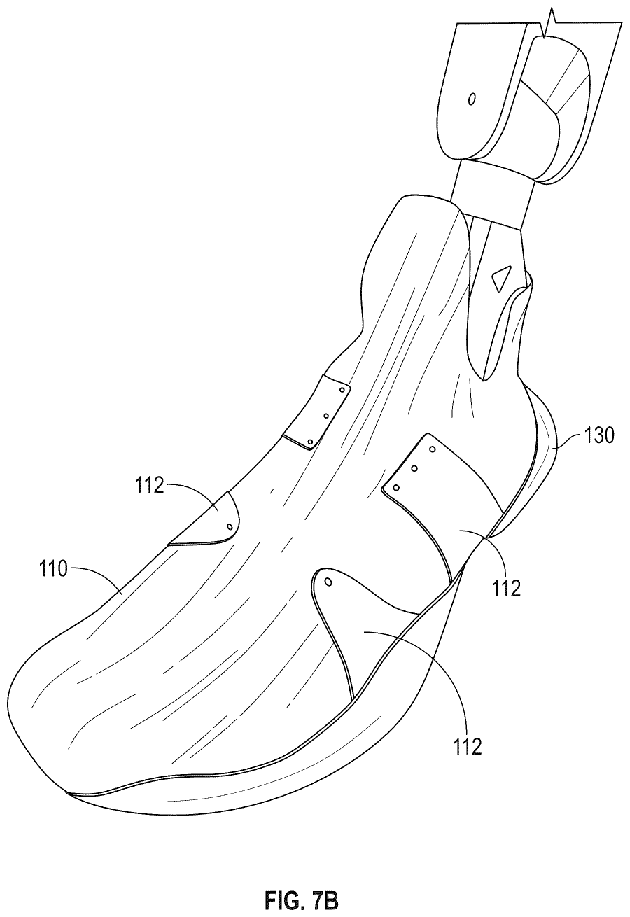

FIGS. 7A and 7B illustrate additional exemplary embodiments with secondary components applied to a lasted component using the methods and systems described herein. In particular, the applied components include a sole structure 130, a plurality of secondary components 112 provided throughout the main body of the lasted component 110 to improve the structure and/or appearance of the article of footwear, and pull tabs 146 bonded to the lasted component 110 adjacent an opening in the lasted component 110. The plurality of secondary components 112 in FIGS. 7A and 7B can comprise any suitable material for any desired structural and/or aesthetic functionality.

As discussed above, various materials and components can be applied to a lasted component using the methods and systems described herein, including, for example, larger components such as sole structures and smaller components such as small sections or strips of textiles or other materials. Any or all of the following components can be applied to the lasted component (either to the lasted component's base layer or to other layers that have been built up or added to the base layer using the methods described herein or other methods): sections and/or strips of material, panels of materials, such as textile panels, mesh composite panels; foxing panels or strips that secure a joint where the upper and sole structure meet, extending along a portion of the joint or substantially encircling the entire shoe; wraps that extend completely or partially around a portion of the lasted component (e.g., midfoot wraps); toe and/or heel members, such as toe and heel bumpers or the like; films; treads or other traction elements; and tension members that are secured at least in part by bonding at some location along the lasted component, such as cables or strand member that extend from one portion of the lasted component to another (e.g., from the sole structure to a lacing region).

### EXEMPLARY SYSTEMS FOR PREPARING AND HANDLING SECONDARY COMPONENTS

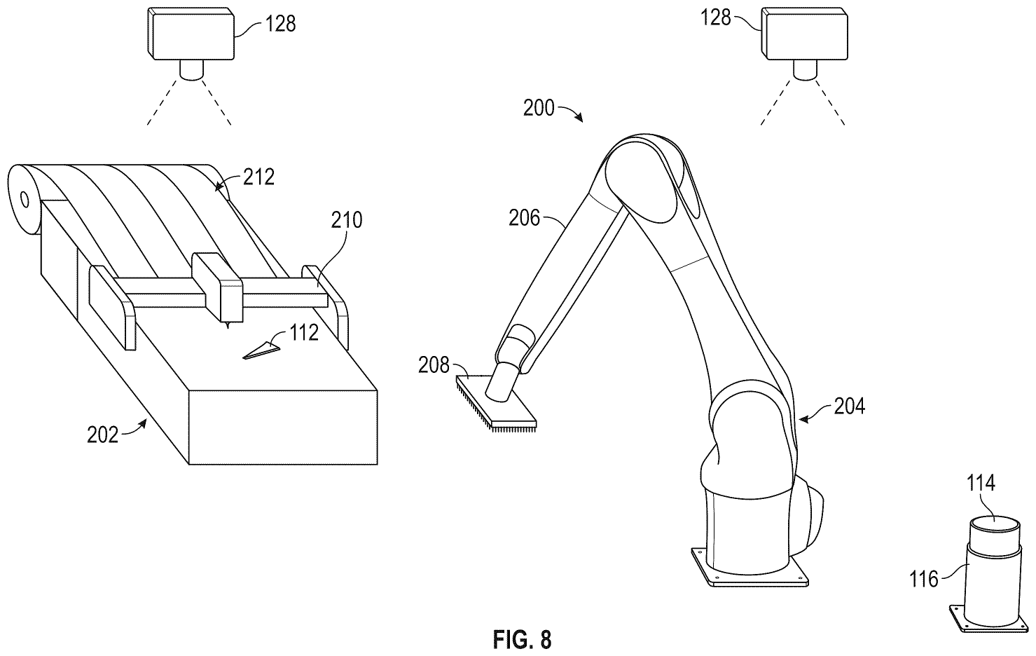

FIGS. 8-10 illustrate a material delivery station 200 for delivering secondary components from a material area 202 to a receiving station 116. Material delivery station 200 can comprises any conveyance mechanism for picking and placing secondary components in position for application to a lasted component. In one embodiment, a second multi-axis robot 204 with an arm 206 is coupled to a gripper 208. Gripper can comprise any device capable of gripping, such as by grasping, lifting, pulling, and/or suction.

Referring to FIG. 8, gripper 208 can comprise a vacuum gripping system that, upon application of a suction force, is capable of safe and damage-free gripping of secondary components of different materials, sizes (e.g., length, width, and thickness), and weights. Thus, for example, the vacuum gripping system can pick and place larger items, such as sole structures, as well as smaller items, such as small strips of textiles or other materials. As in other embodiments, one or more machine vision sensors, such as imaging devices 128, can be provided to facilitate pickup and placement of secondary components as shown in FIGS. 8-10.

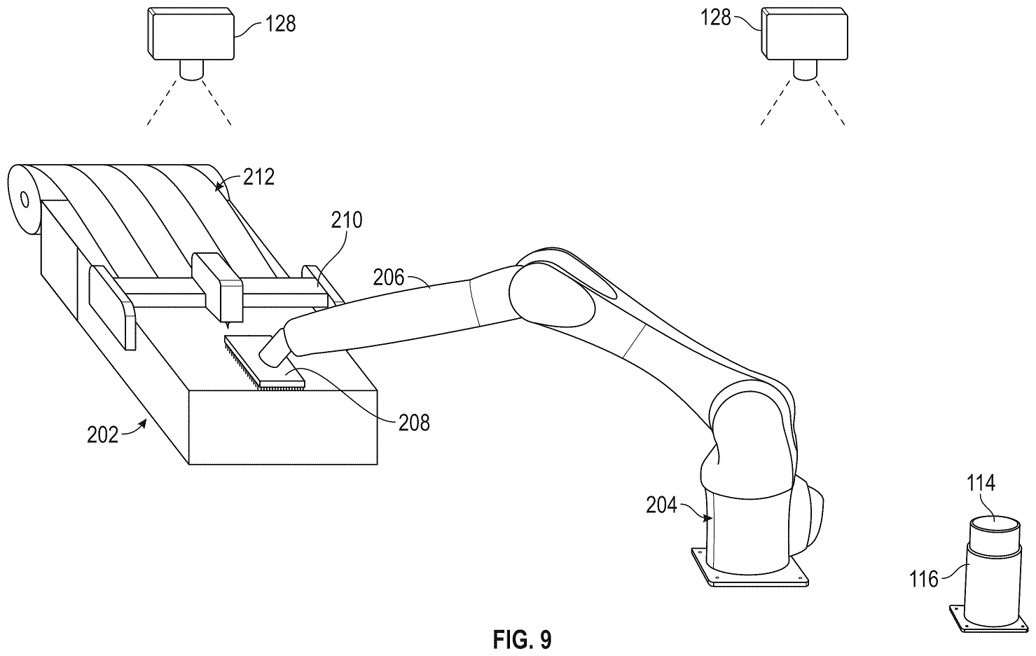

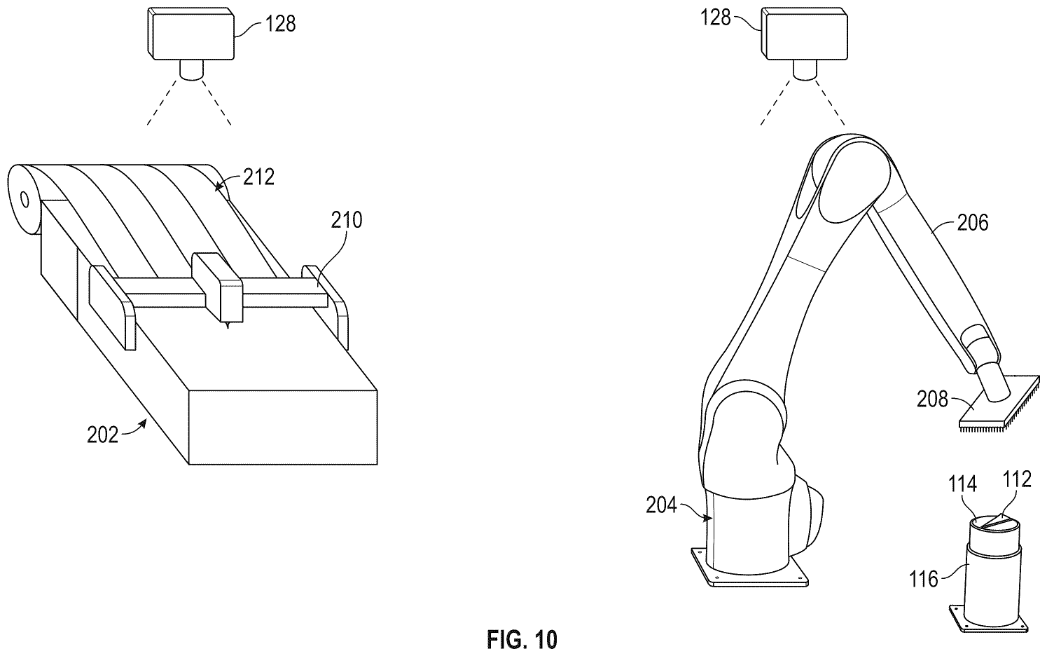

FIG. 8 illustrates the secondary component 112 at the material area 202, FIG. 9 illustrates the secondary component 112 being picked up by gripper 208, and FIG. 10 illustrates the secondary component after being released by the gripper and disposed on a surface 114 of the receiving station 116.

Material area 202 can comprise a cutting device 210. Cutting device 210 can receive materials for the secondary components from a source 212 (e.g., a roll of a flexible material) and perform, on demand, one or more cutting operations to obtain a secondary component of a desired size and shape. In some embodiments, the source 212 can comprise flexible roll materials, such as slit-rolled goods that are fed to the cutting device 210. As used herein, the term “flexible roll material” refers to any material that can be dispensed from a roll. Examples of flexible roll materials include textile, natural fabric, synthetic fabric, knit, woven material, nonwoven material, mesh, leather, synthetic leather, polymer, rubber, and foam, or any combination of thereof.

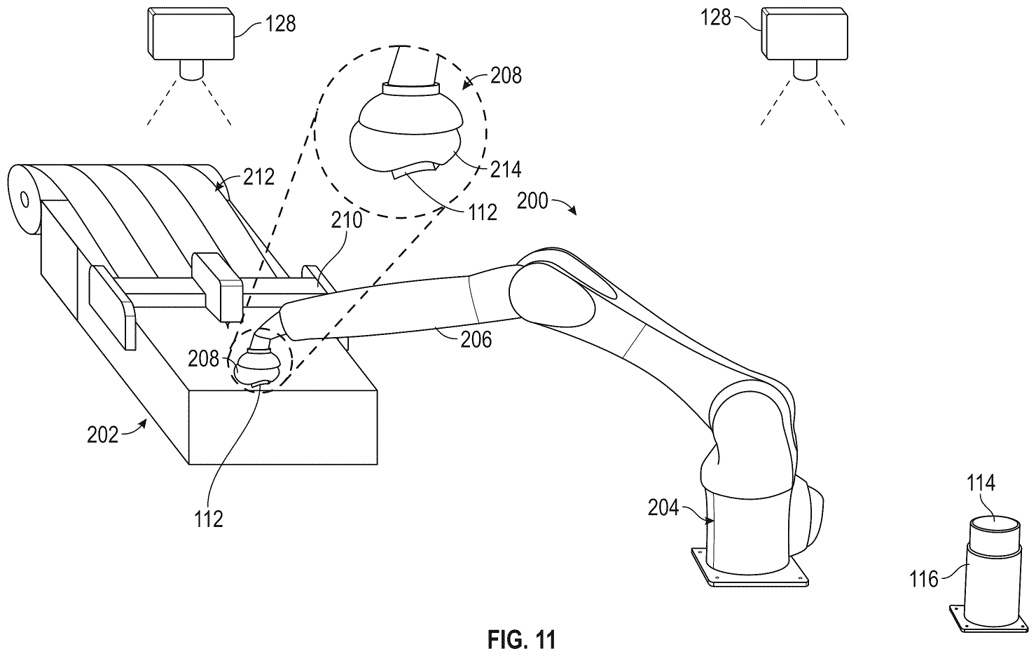

FIG. 11 illustrates another material delivery station 200 that utilizes a different gripper 208. Instead of operating as a suction gripper, gripper 208 in FIG. 11 has a flexible housing that at least partially surrounds the secondary component to pick it up. For example, the gripper can include a flexible housing 214 (e.g., a rubber housing) with a material enclosed within a volume defined by the flexible housing. The material within the flexible housing can comprise, for example, granular particles, such as sand or coffee grounds, that can transition from a flowable state to a more solid state based on pressure changes within the rubber housing. In particular, at atmospheric pressure, the granular particles can freely flow within the rubber housing; however, when a vacuum is applied and an internal pressure of the flexible housing reduced, the granular particles transition to a more solid state. Thus, in operation, as the gripper moves into contact with a secondary component, a vacuum is applied to the rubber housing and gripper 208 locks in place, forming a rigid structure around the secondary component. The rigid structure, having at least partially surrounded or encased at least a side surface of the secondary component, exerts a gripping force on the secondary component that is sufficient for the robot 204 to convey the secondary component from the material area 202 to the receiving station 116.

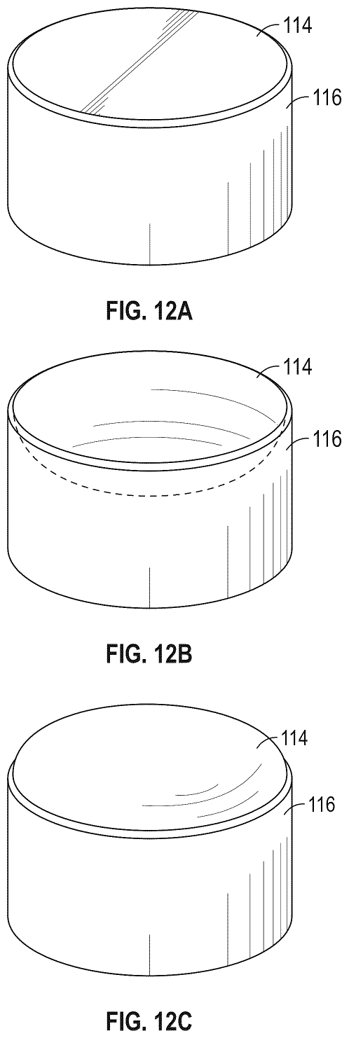

The receiving station can be any structure capable of receiving a secondary component and holding the secondary component in place for application to a lasted component as described herein. For example, FIGS. 12A-12C illustrate exemplary receiving stations 116 that comprise cylindrical platforms or pedestals. Of course, other shapes can be used. In FIG. 12A the receiving station 116 is illustrated with a surface 114 that is flat, in FIG. 12B the receiving station 116 is illustrated with a surface 114 that is concave, and in FIG. 12C the receiving station 116 is illustrated with a surface 114 that is convex.

To better retain a secondary component on the surface 114 of the receiving station 116, a vacuum system can be provided to exert a force (e.g., a suction force) on a lower surface of the secondary component to maintain the position of the secondary component on the surface 114 during at least a portion of the application process. For example, the vacuum system can be configured to apply a vacuum, through one or more apertures in surface 114, thereby holding the secondary component in place on the surface 114.

In addition, or alternatively, the surface material of the receiving station can be selected to have a greater stickiness (i.e., increased friction between the surface and the secondary component). For example, surface 114 can be an anti-slip surface that has a high coefficient of friction due to texturing, one or more coatings, or the selection of the surface material itself.

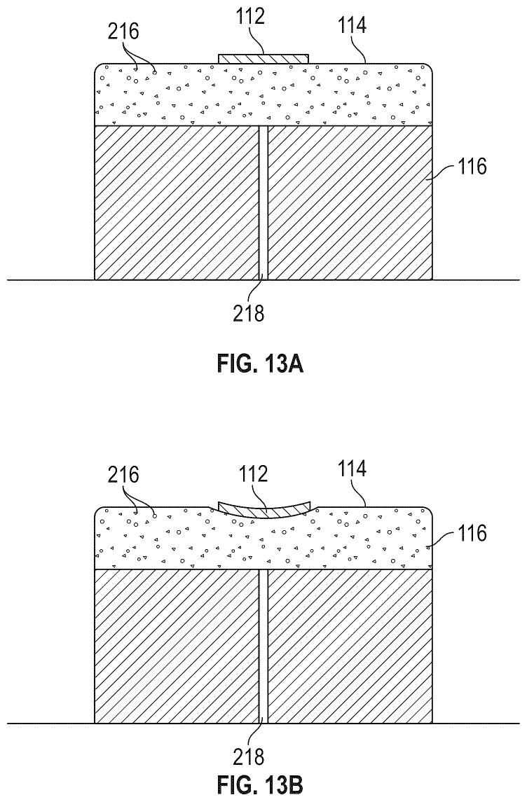

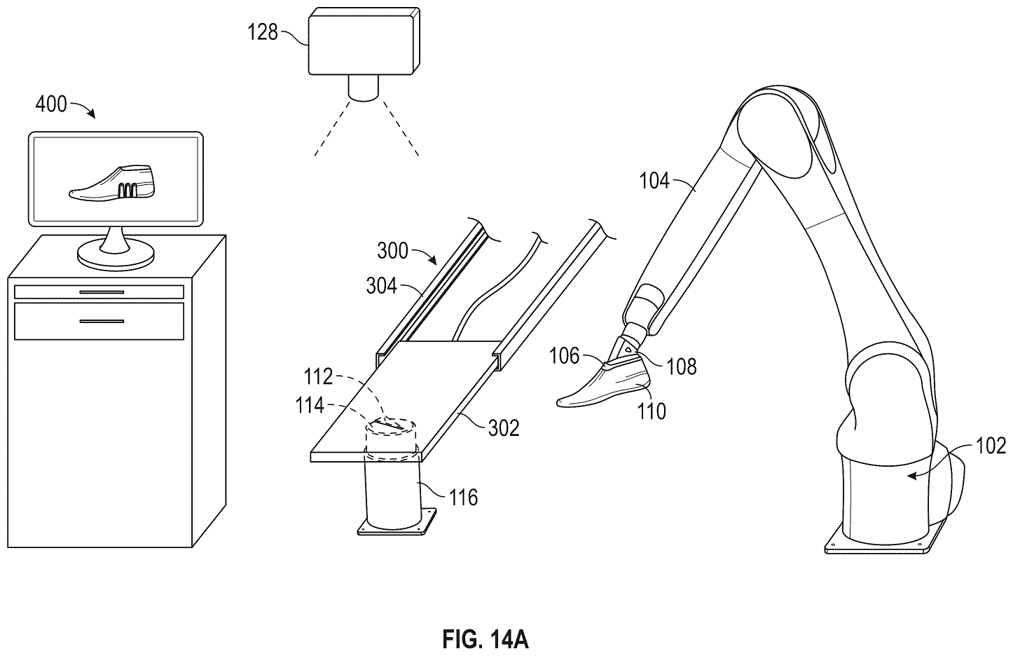

In some embodiments, the receiving station can comprise a surface similar to that described above in connection with gripper 208. For example, surface 114 can comprise a flexible material, such as a rubber housing, that surrounds (at least in part) granular particles 216, such as sand or coffee grounds, that can transition from a flowable state to a more solid state based on pressure changes within the rubber housing. Thus, for example, at atmospheric pressure, the granular particles can freely flow within the rubber housing and the surface 114 acts as an ordinary surface as shown in FIG. 13A. However, when a vacuum is applied (e.g., through one or more apertures 218, the granular particles 216 transition to a more solid state. Thus, as the surface 114 transitions to the more solid state, the flexible housing at least partially collapses, causing portions of the surface 114 to move into contact with at least a portion of the side surface of the secondary component 112, thereby forming a rigid structure around the secondary component 112. With the rigid structure of the surface 114 at least partially surrounding or encasing a side surface of the secondary component 112, the surface 114 exerts a gripping force on the secondary component 112 that is sufficient to restrict movement of the secondary component 112 during at least a portion of the application process. In some embodiments, the surface 114 collapses to engage with only the side surface of the secondary component 112. For example, the surface 114 can collapse to engage with substantially all of the side surface (100% of a thickness of the side surface) or only a portion of the lower area of the side surface of the secondary component (e.g., less than 100% of the thickness of the side surface). In some embodiments, the surface 114 contacts less than 75% of the thickness of the side surface. In other embodiments, the surface 114 contacts less than 50% of the thickness of the side surface. In other embodiments, the surface 114, in its collapsed state, contacts between 10% and 90% of the thickness of the side surface. By contacting less than all of the side surface of the secondary component, the surface 114 of the receiving station can grip the secondary component while leaving the upper surface of the secondary component exposed for bonding with another component (e.g., lasted component 110).

### ADDITIONAL EMBODIMENTS OF SYSTEMS FOR APPLYING SECONDARY COMPONENTS TO ARTICLES

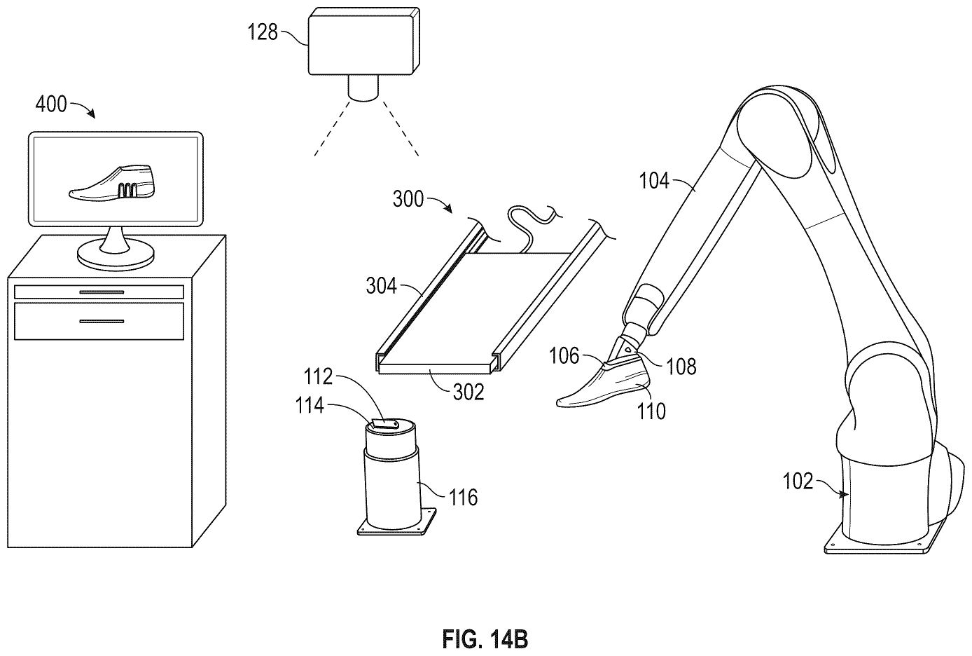

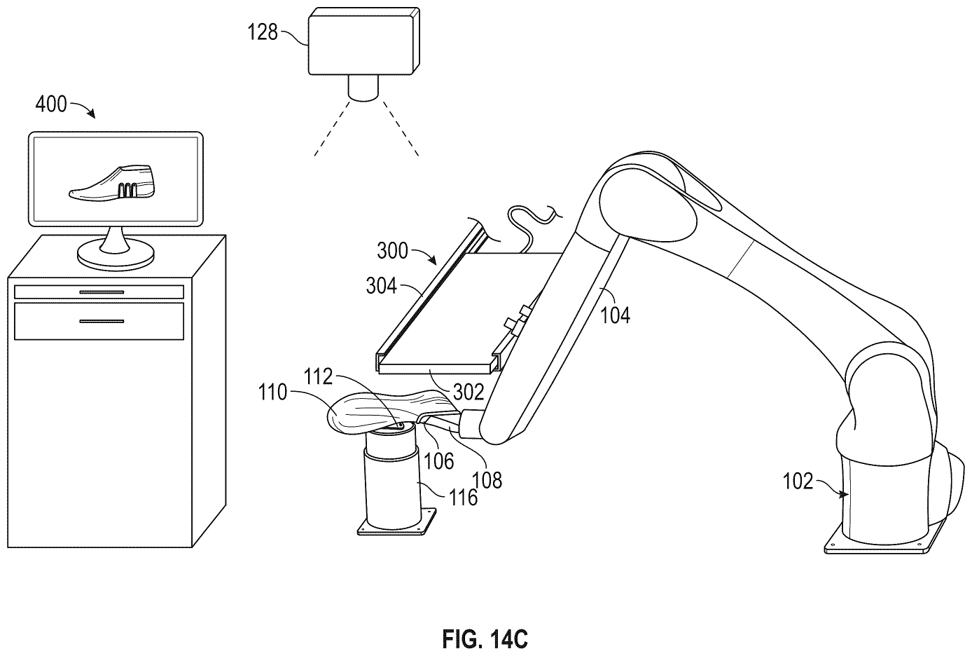

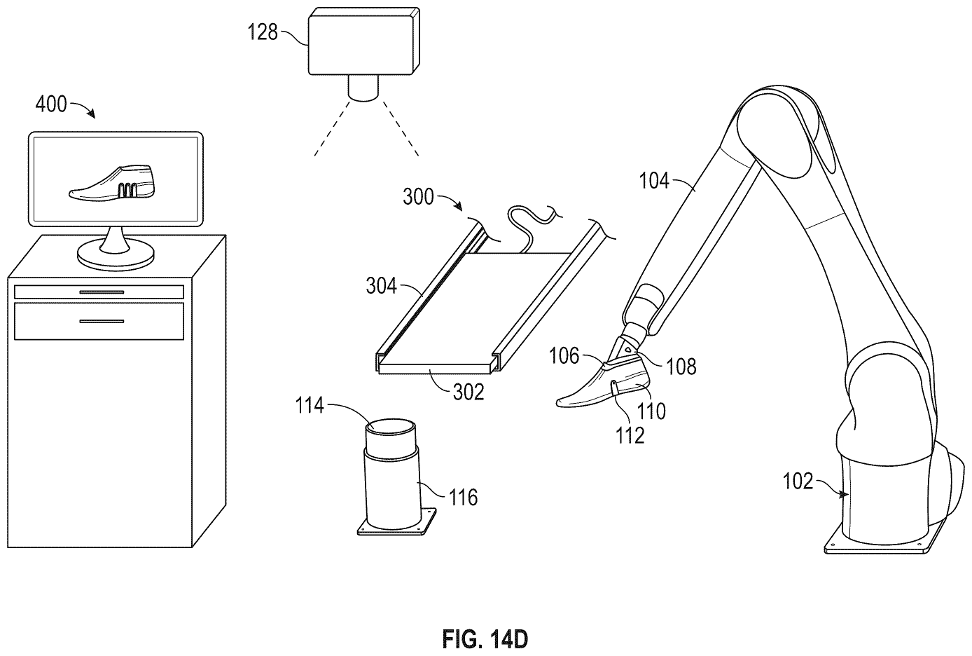

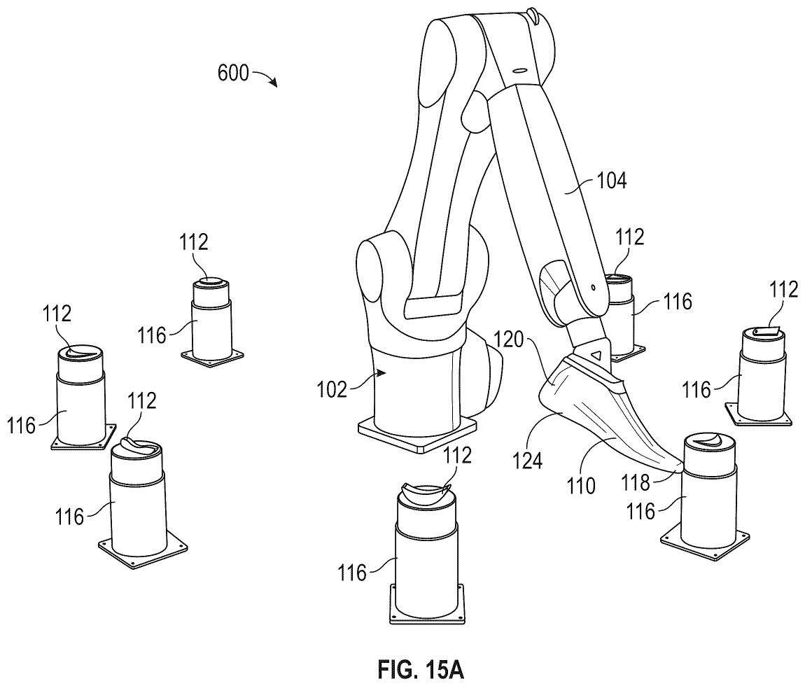

FIGS. 14A-14D illustrate another exemplary system for applying secondary components to a lasted component (e.g., lasted component 110). FIGS. 14A-14D are similar to FIGS. 1-3, but further include a heating system 300 configured to deliver a suitable amount of heat and/or radiation to a bonding material of the secondary component and a computing system 400 to control the operation of the different components of the system.

As discussed above, in some embodiments, the secondary component 112 has a bonding material on an upper surface (e.g., an exposed surface) so that contact between the lasted component 110 and the bonding material on the surface of the secondary component 112 results in the adhesion between the two. Bonding includes bonding through use of glue or other adhesives, through melting and subsequent solidification of a bonding material, and/or through melting and subsequent solidification of a substituent element.

In some embodiments, the bonding material can comprise any suitable thermoset (e.g., thermosetting polymer, resin, or plastic material) or thermoplastic material. For example, the bonding material can be a polyurethane reactive adhesive (PUR). The bonding material can be applied to the secondary component after being received at the receiving station 116 (e.g., by spraying) and/or the bonding material can be applied before the secondary component is disposed on the receiving station. For example, referring again to FIGS. 8-10, the cutting device 210 can form secondary components from materials (e.g., rolled goods) that already have a bonding component applied to one side of the material.

Heating system 300 can be provided to selectively deliver heat and/or radiation to the bonding material at the receiving station 116. For example, in the exemplary embodiment of FIGS. 14A-14D, a heating element 302 (e.g., a flash tray) is supported by a support member 304 that allows the heating element 302 to move from a first position that is further away from the location of the secondary component (e.g., FIG. 14B) to a second position that is closer to the secondary component (e.g., FIG. 14A). In the second position—the heating position—the heating elements 302 can be positioned, for example, directly above the secondary component.

The operation of heating system 300 can be controlled by computing system 400 to synchronize heating of the bonding material with the application of the secondary component 112 to the lasted component 110. For example, as shown in FIG. 14A, computing system 400 can cause the heating system to move into position to deliver heat and/or radiation to the upper surface of the secondary component (e.g., to the bonding material) immediately before the lasted component 110 moves into contact with the secondary component (FIG. 14C). If the heating position (i.e., operating position) of the heating system 300 would interfere with the movement of the lasted component 110 into contact with the secondary component 112, the heating element can be directed to return to its first position (i.e., the non-operating position shown in FIG. 14B) before moving the lasted component 110 into contact with the secondary component 112. Optimal bonding can be achieved by synchronizing the heating of the bonding material with the movement of the lasted component into contact with the secondary component. As shown in FIG. 14D, after the lasted component 110 contacts the secondary component 112 for as long as necessary to ensure sufficient bonding between the lasted component 110 and secondary component 112, the lasted component 110 can move away from the receiving station 116 with the secondary component 112 secured to the lasted component 110.

The timing of the flash heating/radiating and the application of pressure (e.g., time and amount) to secure a component to an article can vary depending on the component and/or the bonding material used. Although a wide variety of ranges are possible, Table 1 below illustrates several exemplary ranges.

| | | |
|---|---|---|
| Action | Fabric | Bottom (e.g., sole) |

| | | | | |
|---|---|---|---|---|
| Flash | 2-8 | seconds | 15-20 | seconds |
| Press/hold | 5-15 | seconds | 40-80 | seconds |
| Pressure | 1-20 | psi | 1-20 | psi |

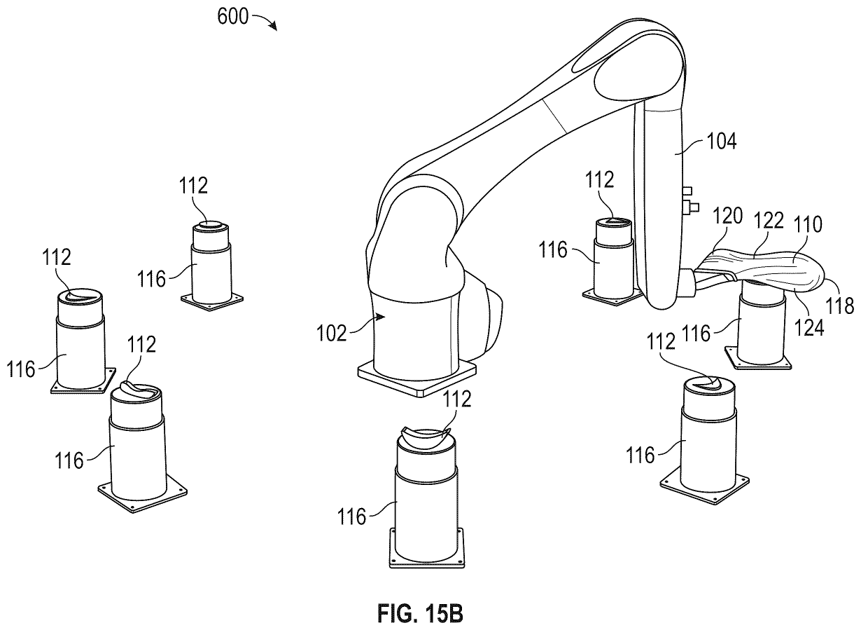

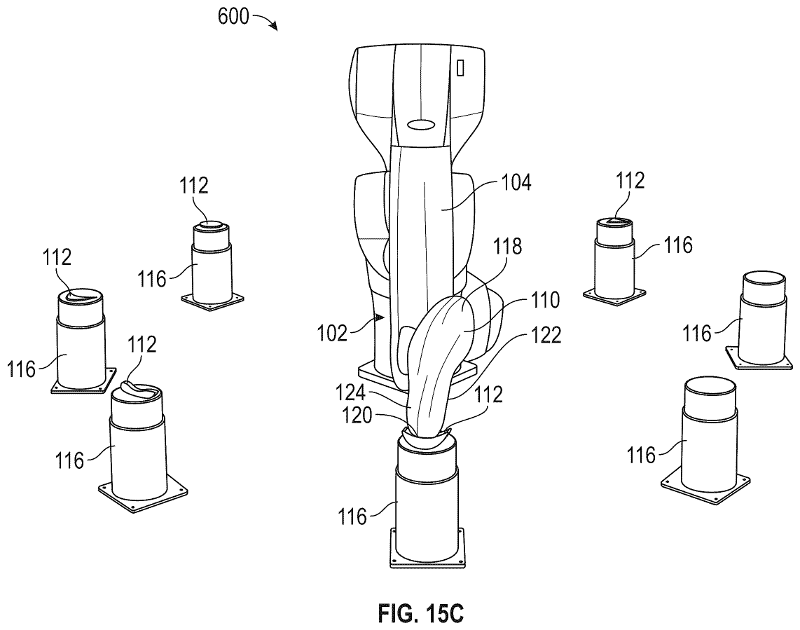

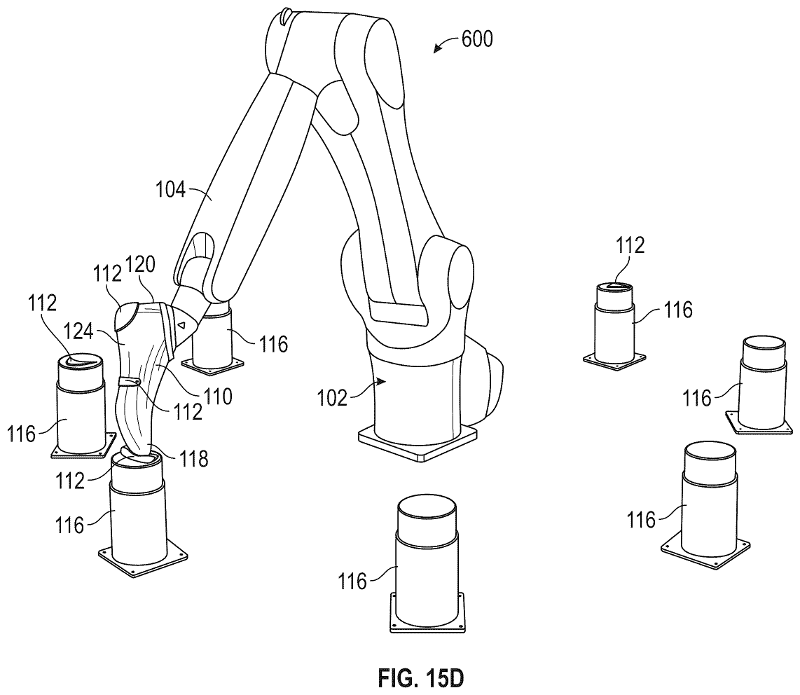

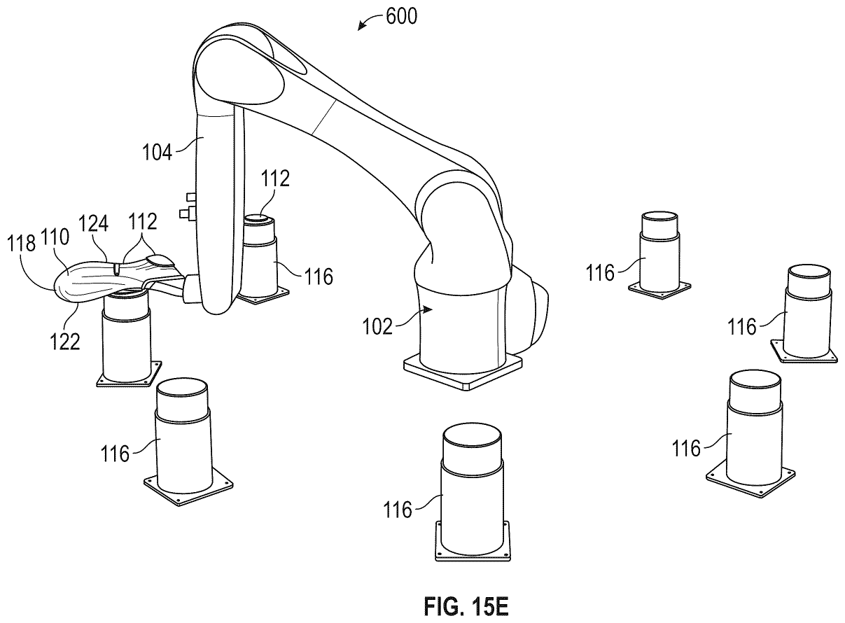

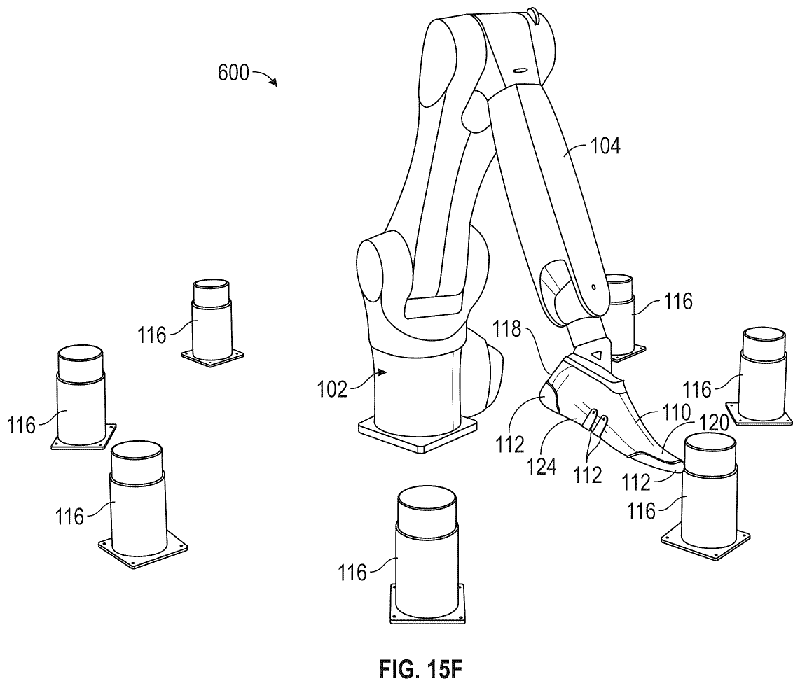

FIGS. 15A-F illustrate an exemplary system 500 that includes a plurality of different receiving stations 116 that can be used in combination with a multi-axis robot 102 as described elsewhere herein. As in other embodiments, a lasted component 110 of an article of footwear can be positioned on the last 106. The lasted component 110 can be moved into contact with one or more secondary components 112 that are positioned on a plurality of receiving stations 116.

The use of a plurality of receiving stations 116 can allow for sequential application of different secondary components to the lasted component 110. In addition, the application process can be more efficient, with additional secondary components being prepared and moved into position on a downstream receiving station to permit continuous, or nearly continuous, operation of the system.

For example, an example of the sequential application of secondary components 112 to a lasted component 110 is illustrated in FIGS. 15A-15F. In the example, the lasted component 110 can be prepared (FIG. 15A) and then moved into contact with a first secondary component 112 (FIG. 15B) to apply the first secondary component to the lateral side 124 of the lasted component 110. After application of the first secondary component 112, the lasted component 110 can move to another receiving station 116 to receive a second secondary component, such as the heel member shown in FIG. 15C. After application of the second secondary component to the heel end 120 of the lasted component 110, the lasted component 110 can move to another receiving station 116 to receive a third secondary component, such as the toe member shown in FIG. 15D. Again, the lasted component 110 can move to another receiving station to receive another secondary component, such as a fourth secondary component that is applied to the medial side 122 of the lasted component 110 as shown in FIG. 15E. After all desired secondary components are applied to the lasted component 110 (FIG. 15F), the lasted component 110 can be removed from the last 106 and/or subjected to further processing. Any number of receiving stations can be provided, such as two to ten, two to eight, or two to five.

In some embodiments, the secondary components can be replenished so that the same receiving station may be used for multiple applications of materials to the lasted component. Alternatively, or in addition, the receiving stations can be moveable, with different receiving stations moving into position (i.e., within the operation reach of the multi-axis robot) with additional secondary components already disposed thereon.

### EXEMPLARY CONTROL SYSTEMS AND COMPUTING SYSTEMS

As discussed above, the systems and method described herein can achieve highly accurate placement of secondary components on articles. To achieve highly accurate placement, the location of the secondary materials prior to application should be known. In some embodiments, the accurate placement of the secondary materials can be achieved by disposing the secondary components in a known location at a high degree of accuracy. With the location of the secondary materials being known, the multi-axis robot can be controlled, using conventional robotic systems, to move the lasted component (or other article) into position for bonding with the secondary component.

In other embodiments, machine vision sensors, such as one or more imaging devices 128, can be provided to facilitate robot guidance and identify the location and orientation of the secondary components 112 to achieve highly accurate application of the secondary components 112 to the lasted component 110. Imaging devices 128 can be any kind of device capable of capturing image information. Examples of different imaging devices that can be used include, but are not limited to any type of cameras (e.g., still-shot, video, digital, non-digital), as well as other kinds of optical sensing devices known in the art. The type of optical sensing device may be selected according to factors such as desired data transfer speeds, system memory allocation, and desired resolutions.

The location of the imaging devices can be fixed relative to the receiving stations. Alternatively, the imaging devices can be mounted on moving components, such as the robotic arm 104, to identify locations of, for example, the secondary components relative to the lasted component.

Imaging devices 128 may convert optical images into information transmitted via electrical signals to one or more suitable computing systems. Upon receiving these electrical signals, the one or more systems can use this information to determine a variety of information about objects (e.g., secondary components, lasted components) and their locations (e.g., position and orientation) that may be visible to the imaging devices 128. This information can be converted to a Cartesian coordinate system, which, in combination with a known position of the lasted component, can be used to calculate an appropriate trajectory path for the lasted component using available industrial robot software.

In some embodiments, the operation of the multi-axis robot can be programed by “teaching” the robot art to move in a desired manner by moving it manually from point to point and recording these point-to-point moves as the robot's motion commands. For example, U.S. Pat. No. 8,489,236, entitled “Control Apparatus and Control Method for Robot Arm, Robot, Control Program for Robot Arm, and Integrated Electronic Circuit” discloses systems for training robots in this manner and is incorporated by reference herein in its entirety. In other embodiments, operation of the multi-axis robot can be performed using, at least in part, machine vision as described in U.S. Pat. No. 9,701,015, entitled “Vision-guided Robots and Methods of Training Them” and U.S. Pat. No. 9,987,746, entitled “Object Pickup Strategies for a Robotic Device,” both of which are incorporated herein in their entirety.

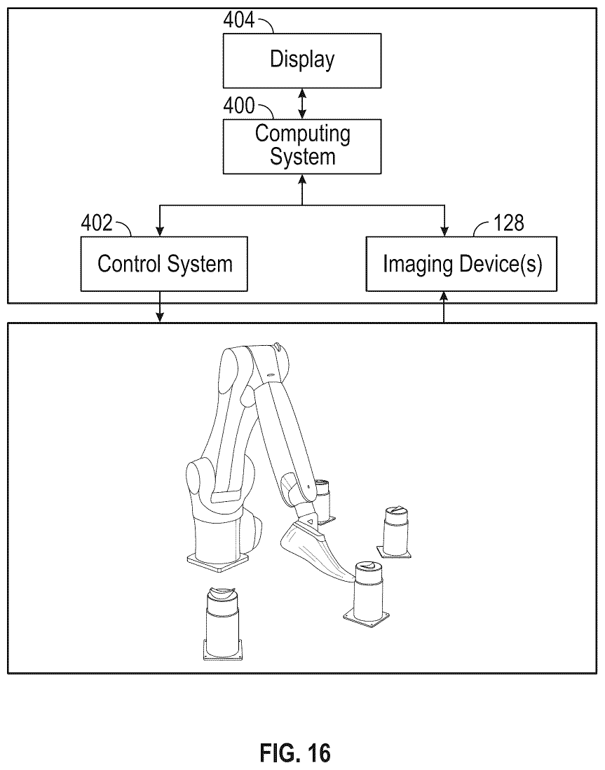

FIG. 16 illustrates a schematic view of an embodiment that includes a computing system 400, a control system 402, display 404, and imaging devices 128. The computing system 400 is configured to receive information from the one or more imaging devices 128 regarding the location, orientation, and type of components in the system (e.g., robotic arm 104, lasted component 110, secondary components 112, etc.) and, based on that received information and the intended design of the article of apparel, provide operating instructions to the control system 402 to take certain actions (e.g., movement of the robotic arm, heating bonding materials, cutting secondary components, conveying secondary components, etc.).

Control system 402 can control the operation of the various systems, including one or more multi-axis robots associated with a lasted component and/or a material delivery station and any other desired processing equipment. For example, control system 402 can also control other systems associated with preparing secondary components for contact with an article, such as cutting station equipment that forms the secondary components into desired shapes and/or structures, and heating systems configured to deliver a suitable amount of heat and/or radiation to a bonding material on surfaces of the secondary components. As discussed above, the heating system is preferably controlled to deliver synchronized heating to secondary components, as needed, to achieve optimal bonding between the secondary component and the lasted component.

In some embodiments, the computing system 400 receives information about the materials, including the bonding material, lasted component, and secondary component, and selects a heating sequence based on the materials and related design information. The computing system 400 then can provide a series of instructions to the control system 402, which in turn causes the heating system to move into position, apply a desired amount of heat/radiation, and move out of position, while the control system 402 causes the lasted component to move into position for contact with the secondary component immediately after the bonding material is heated/irradiated.

Based on the information from the imagine devices, the computing system can be configured to use software to calculate a desired motion of the lasted component to come into contact with the secondary materials in a desired manner. For example, based on a desired outcome, the lasted component can come into contact with the entire surface of the secondary component at once and/or engage in a sequential manner (e.g., by rolling a portion of the lasted component over the secondary component to engage with different areas of the secondary component at different times). In addition, as discussed above, longer or shorter contacts may be appropriate depending on the secondary materials, the bonding materials, and/or a desired design result.

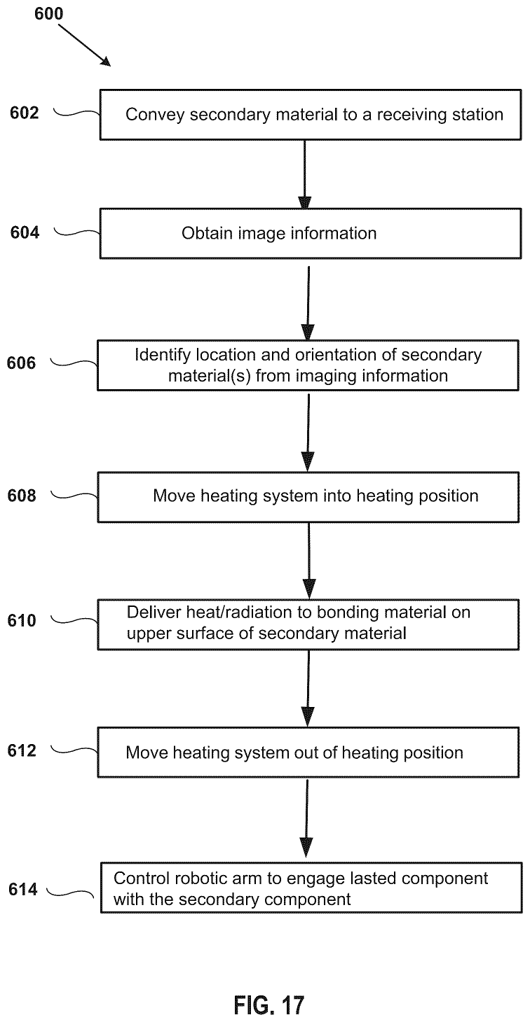

FIG. 17 illustrates depicts an exemplary method 600 for applying a secondary component to an article (e.g., a lasted component). The method 600 can comprise conveying a secondary material to a receiving station (process block 602). The secondary material can be conveyed as described herein or in any other desired manner. The method 600 can include obtaining imaging information from the one or more imaging devices (process block 604). Image information can be taken in any manner, including those described herein, and can be obtained continuously or at one or more different discrete times in the process. From the image information, the location and orientation of the secondary materials can be determined (process block 606). Additional information can be obtained and used by the system from image devices, such as tracking the operation of other systems (e.g., cutting, heating, material transfer systems) and/or identifying other aspects of the secondary components (e.g., material, shape, structure, etc.). As shown in FIG. 17, a heating system can move into a heating position (process block 608), deliver heat/radiation to a bonding material on an upper surface of the secondary material (process block 610), and move out of the heating position (process block 612) to allow the lasted component to engage the secondary component more easily. Finally, the computing system use software to calculate a desired motion of the lasted component and control the robotic arm so that the lasted component moves in the desired manner to engage with the secondary material (process block 614).

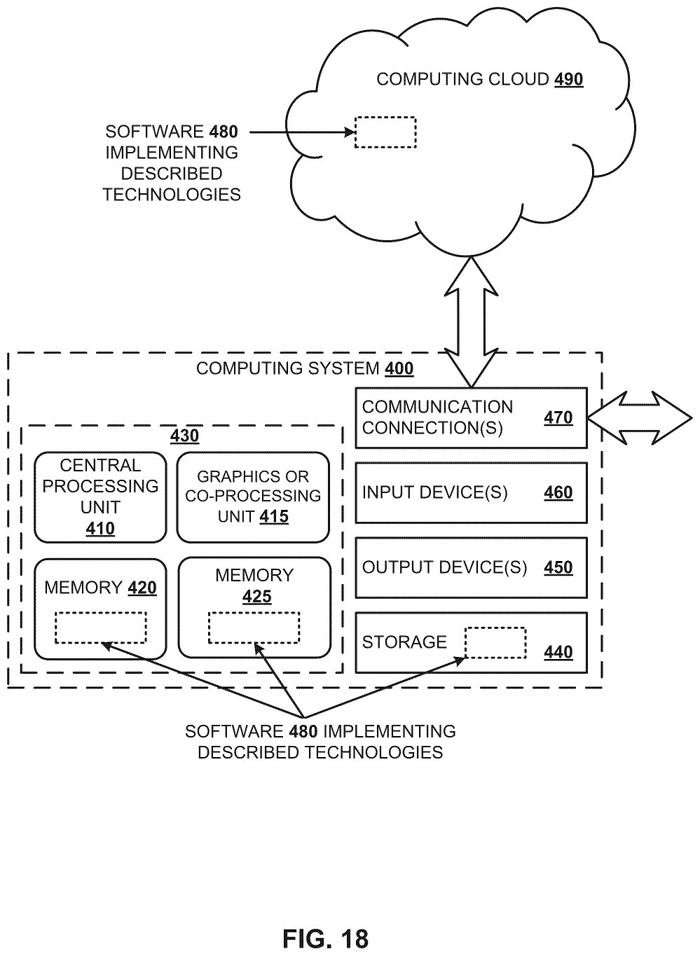

FIG. 18 depicts a generalized example of a suitable computing system 400 in which the described innovations may be implemented. The computing system 400 is not intended to suggest any limitation as to scope of use or functionality, as the innovations may be implemented in diverse general-purpose or special-purpose computing systems. For example, the computing system 400 can be used to implement hardware and software.

With reference to FIG. 18, the computing system 400 includes one or more processing units 410, 415, non-volatile memory 420, and memory 425. In FIG. 18, this basic configuration 430 is included within a dashed line. The processing units 410, 415 execute computer-executable instructions, including instructions for calculating trajectories for the lasted component, calculating desired heating sequences for bonding materials, and coordinating the movements of the systems to achieve the desired application of secondary components to lasted components as disclosed herein. A processing unit can be a general-purpose central processing unit (“CPU”), processor in an application-specific integrated circuit (“ASIC”), or any other type of processor. In a multi-processing system, multiple processing units execute computer-executable instructions to increase processing power. For example, FIG. 18 shows a central processing unit 410 as well as a graphics processing unit (“GPU”) or co-processing unit 415. The tangible memory 425 may be volatile memory (e.g., registers, cache, RAM), non-volatile memory (e.g., ROM, EEPROM, flash memory, etc.), or some combination of the two, accessible by the processing unit(s). The memory 425 stores software 480 implementing one or more innovations described herein, in the form of computer-executable instructions suitable for execution by the processing unit(s).

A computing system may have additional features. For example, the computing system 400 includes storage 440, one or more input devices 450, one or more output devices 460, and one or more communication connections 470. An interconnection mechanism (not shown) such as a bus, controller, or network interconnects the components of the computing system 400. Typically, operating system software (not shown) provides an operating environment for other software executing in the computing system 400, and coordinates activities of the components of the computing system 400.

The tangible storage 440 may be removable or non-removable, and includes magnetic disks, magnetic tapes or cassettes, CD-ROMs, DVDs, or any other medium which can be used to store information and which can be accessed within the computing system 400. The storage 440 stores instructions for the software 480, such as the industrial robot software, for implementing one or more innovations described herein.

The input device(s) 450 may be a touch input device such as a keyboard or other devices that provides input to the computing system 400. For video encoding, the input device(s) 450 may be a camera with an image sensor, video card, TV tuner card, or similar device that accepts video input in analog or digital form, or a CD-ROM, CD-RW, DVD, or Blu-Ray that reads video samples into the computing system 400. The output device(s) 460 may be any device that receives an output or that is controlled by the computing system 400 by instructions, or a series of instructions, from the computing system 400 (such as the robotic system with the lasted component, the secondary component cutting station, the pick-and-place system for moving secondary components to the receiving station, and the heating system for directing heat and/or radiation to bonding materials on the secondary components).

The communication connection(s) 470 enable communication over a communication medium (e.g., a connecting network) to another computing entity. The communication medium conveys information such as computer-executable instructions, compressed graphics information, video, or other data in a modulated data signal. The communication connection(s) 470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 490. For example, disclosed computer-readable instructions can be executed by processors located in the computing environment 430, or the disclosed computer-readable instructions can be executed on servers located in the computing cloud 490.

Computer-readable media are any available media that can be accessed within a computing environment 400. By way of example, and not limitation, with the computing environment 400, computer-readable media include memory 420 and/or storage 440. As should be readily understood, the term computer-readable storage media includes the media for data storage such as memory 420 and storage 440, but does not include transmission media such as modulated data signals or other transitory signals.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular data types. The functionality of the program modules may be combined or split between program modules as desired in various embodiments. Computer-executable instructions for program modules may be executed within a local or distributed computing system.

Although certain exemplary embodiments shown herein relate to the manufacture of footwear, the systems and methods disclosed herein can be applied to other manufacturing systems, including manufacturing systems related to articles of apparel other than footwear. FIG. 19 illustrates an article of apparel 700 that is a hat that is supported by a support member 706 of a multi-axis robot 702. Using the same systems and methods disclosed above, one or more components 712 can be applied to the hat while it is supported by support member 706.

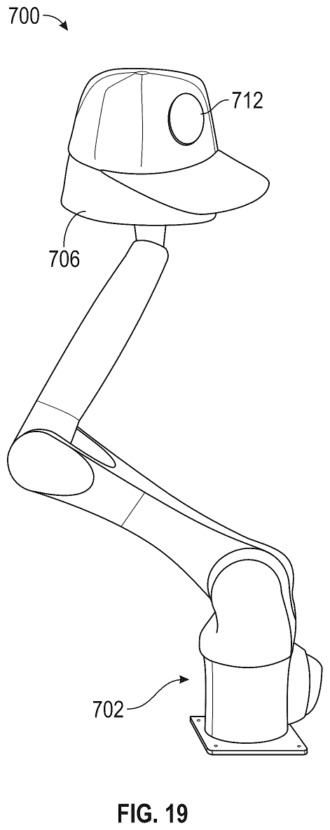

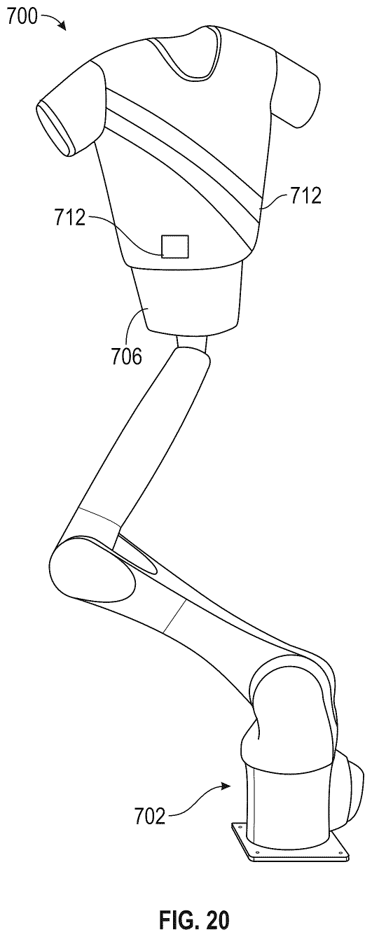

Similarly, FIGS. 20 and 21 illustrate other articles of apparel 700 that can be modified and/or formed using the systems and methods described herein. FIG. 20 illustrates the article as a shirt with a plurality of components 712 attached, and FIG. 21 illustrates the article as a backpack with a plurality of components 712 attached. In any of FIGS. 19-21, the support member 706 can comprise a structure that at least partially supports the article in a similar manner to the lasts described herein with respect to footwear. For example, the support member can be shaped to generally fill at least a portion of an interior volume of an article.

As discussed above, the receiving stations can be any structure capable of receiving a secondary component and holding the secondary component in place for application to a lasted component as described herein. As discussed in more detail below, in other embodiments, the secondary component can be printed directly onto a surface of the receiving station.

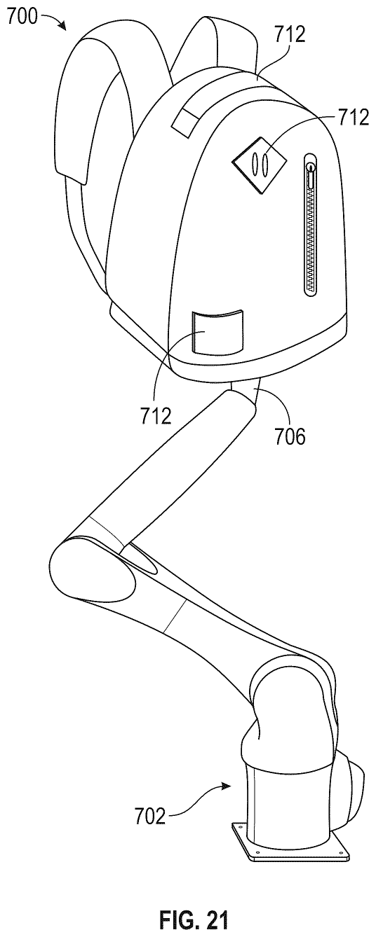

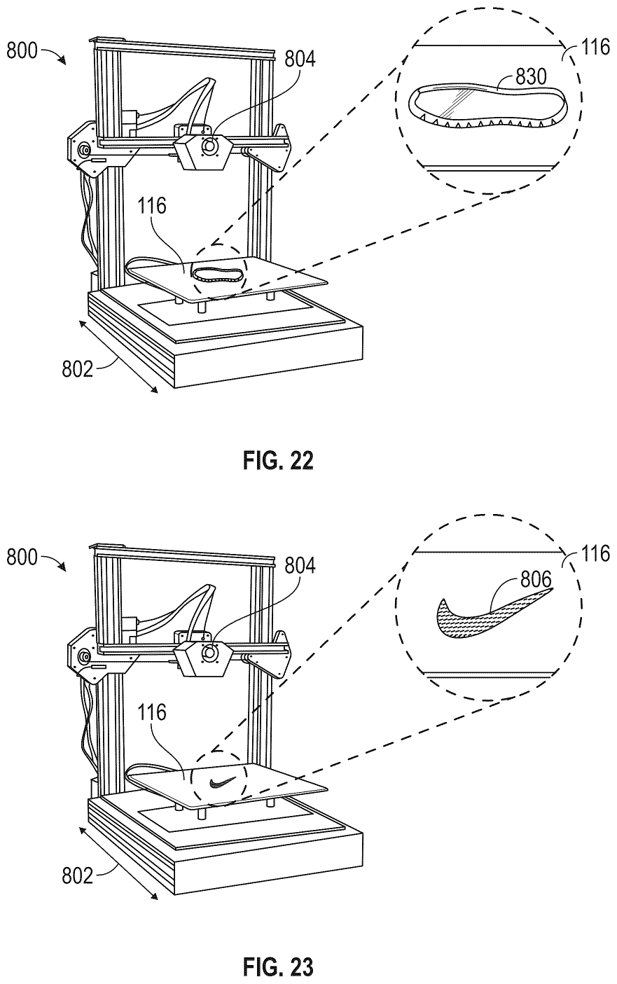

FIGS. 22 and 23 illustrate embodiments in which the secondary component is printed on a surface of a receiving station 116. Accordingly, in these embodiments, the secondary component comprises printed material delivered directly from a printhead assembly 804 onto the receiving station 116. The printed material can comprise a single layer of ink or other printed material that can be transferred onto an article by contact (e.g., the ink layer 806 shown in FIG. 23) or it can comprise one or more layers of printed material (e.g., the sole structure 830 shown in FIG. 22).

Referring to FIG. 22, the receiving station 116 can be positioned so that a secondary component can be directly printed via a printing device 800. For example, in one embodiment, the printing device 800 can be positioned above the receiving station 116 so that it can deliver a printed material onto a surface of the receiving station 116. In other embodiments, the printing device can move relative to the receiving station to facilitate direct printing onto the surface. For example, FIG. 22 illustrates an embodiment in which the receiving station 116 (or alternatively, the printing device) can move in at least one direction, such as horizontal direction 802, to move into a desired position to receive a printed material.

Alternatively, receiving station 116 can be fixed in position with the printing device positioned above the receiving station 116. In such an embodiment, the printing device can comprise any printing system with sufficient access to the surface of the receiving station of the printing device for an article to be moved into contact with the printed material in the manners described herein. In still yet another embodiment, the printing device can be configured so that it can move from a remote location into a desired position above the receiving station 116.

The printing device can be a three-dimensional printing system or printer. As used throughout this disclosure, the terms “three-dimensional printing system,” “three-dimensional printer,” “3D printing system,” and “3D printer” refer to any known 3D printing system or printer. The printed material of the printing device can be received on a surface of the receiving station for transfer to the surface of an article in the manners disclosed herein. If desired, a release layer may be provided on the surface of the receiving station, between the surface of the receiving station and the printed material. Alternatively, the printed material or the material of the surface of the receiving station can be selected so that a release layer is not required.

The printed material can comprise any material capable of being printed or deposited onto the surface of the receiving station. As used throughout this disclosure, the terms “printing” or “printed,” and “depositing” or “deposited,” are each used synonymously, and are intended to refer to the association of a material from a source of the material to a receiving surface or object. The printed material can comprise, for example, a resin, acrylic, ink, polymer, thermoplastic material, thermosetting material, light-curable material, or combinations thereof. The printed material can be selected so that it can be adhered/bonded to a surface of the article when the article is moved into contact with an upper surface of the printed material. Depending on the material of the article (which can, for example, include one or more of a textile, natural fabric, synthetic fabric, knit, woven material, nonwoven material, mesh, leather, synthetic leather, polymers, rubbers, and foam), additional steps can be taken to facilitate bonding. For example, in some embodiments, a surface of the printed material can be heated before bonding as disclosed herein. Alternatively, one or more bonding layers can be printed with the printed material, such that the bonding layer forms an upper surface of the printed material.

The printed material can be formed by printing of one or more layers in a sequence of depositions of material to any desired thickness, and may also include a filler material to impart a strengthening or aesthetic aspect to the printed material. For example, the filler material may be a powdered material or dye designed to impart desired color or color patterns or transitions, metallic or plastic particles or shavings, or any other powdered mineral, metal, or plastic, and may customize the hardness, strength, or elasticity of the printed material depending on desired properties. The filler material may be premixed with the printed material prior to printing, or it may be mixed with printed material during printing. The printed material may thus be a composite material.

In the exemplary embodiment shown in FIG. 22, the secondary component is illustrated as a sole structure 830, similar to the sole structure 130 depicted in FIG. 4A. Of course, it should be understood that any of the structures disclosed herein can be formed by 3D printing the structure directly onto the receiving station.

FIG. 23 illustrates a similar embodiment, but rather than a 3D printed material, the printed material comprises an ink layer 806 that is printed directly on the surface of the receiving station 116.

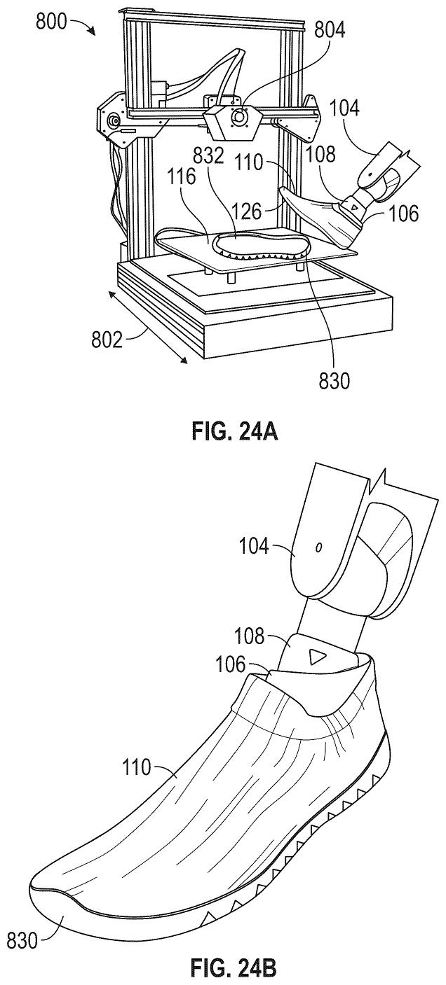

FIG. 24A illustrates a sole structure 830 disposed on a surface of a receiving station 116 for application to a lasted component 110. Lasted component 110 can move into contact with the sole structure 830, either all at once (e.g., directly from above) or through initial contact with a first portion (e.g., a heel region) and then subsequent contact with other portions (e.g., the midfoot and toe region). FIG. 24B illustrates the sole structure 830 after it is bonded to the lower surface 126 of the lasted component 110.

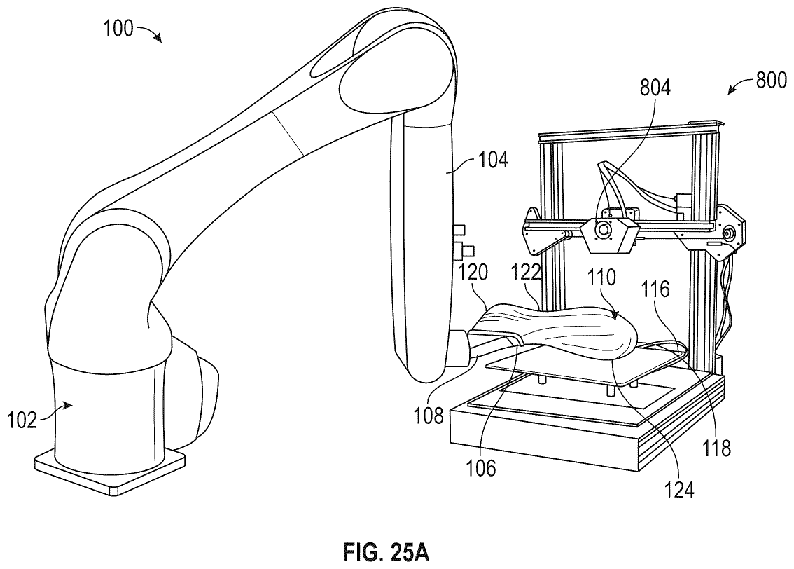

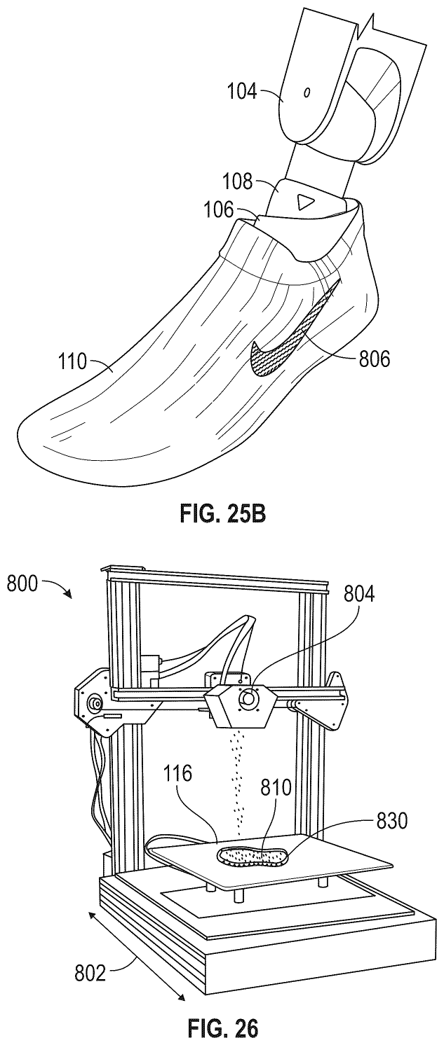

FIG. 25A illustrates the application (i.e., transfer) of the ink layer 806 (shown in FIG. 23) on the receiving station 116 to the lasted component 110. Lasted component 110 is shown in FIG. 25A initiating contact with the ink layer 806 (not shown). FIG. 25B illustrates the ink layer 806 after it has been transferred from a surface of the receiving station to a surface of the lasted component 110.

As discussed above, in some embodiments, the secondary component can have a bonding material on an upper surface (e.g., an exposed surface) to facilitate bonding between an external surface of the lasted component and an upper surface of the secondary component upon contact. Bonding includes bonding through use of glue or other adhesives, through melting and subsequent solidification of a bonding material, and/or through melting and subsequent solidification of a substituent element, but excludes stitching, stapling or similar types of mechanical attachment to structurally connect the substituent elements of the bonded composite. FIG. 26 illustrates an embodiment in which a bonding material 810 is printed directly onto an exposed surface of the secondary component (e.g., sole structure 830).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A method of manufacturing an article of apparel comprising:
securing a first component to a support structure coupled to an arm of a first multi-axis robot, the first component forming at least a portion of the article of apparel and having an external surface;
disposing a second component on a surface of a receiving station, the second component comprising a material that has an upper surface and a lower surface, the lower surface facing the surface of the receiving station;
attaching the upper surface of the second component to the external surface of the first component by moving the arm of the multi-axis robot from a first position in which the first component is spaced apart from the second component to a second position in which the external surface of the first component is in contact with the upper surface of the second component; and
moving the first component away from the receiving station with the second component attached to the external surface of the first component.

2. The method of claim 1, wherein the upper surface of the second component comprises a bonding material that secures the upper surface of the second component to the external surface of the first component upon contact and the method comprises directing heat and/or radiation at the bonding material before moving the first component into contact with the second component.

3. The method of claim 1, further comprising capturing image information from an area of the one or more receiving stations to identify a position and orientation of the second components when received on the receiving station.

4. The method of claim 1, further comprising directing heat and/or radiation from a heating system toward the upper surface of the one or more receiving stations prior to or during the attaching of the upper surface of the second component to the external surface of the first component.

5. The method of claim 4, further comprising moving the heating system between a first position and a second position, and the second position being an operating position in which the heating system can direct heat and/or radiation toward the upper surface of the one or more receiving stations and the first position is a non-operating position in which the heating system is spaced further away from the upper surface than in the second position.

6. The method of claim 5, wherein the heating system is coupled to one or more rail members and the heating system can move from the operating position to the non-operating position along the one or more rail members.

7. The method of claim 1, wherein the upper surface of the receiving station is selected to restrict relative movement between the upper surface of the receiving station and respective lower surface of the second component when received thereon.

8. The method of claim 1, further comprising applying a suction force at the upper surface of the one or more receiving station to restrict movement of the second component on the surface of the receiving station.

9. The method of claim 8, wherein the application of the suction force is achieved by applying to vacuum device to a flexible housing of the receiving surface, the flexible housing being at least partially collapsible when an internal pressure of the flexible housing is reduced by the vacuum device.

10. The method of claim 1, further comprising a cutting out the second component from a material source before disposing the second component on the surface of the receiving station.

11. The method of claim 10, wherein the material source is a flexible roll material.

12. A method of manufacturing an article of apparel, comprising:
securing a first component to a support structure coupled to an arm of a multi-axis robot, the first component forming at least a portion of the article of apparel and having an external surface;
disposing a second component on a surface of a receiving station, the second component comprising a material with an upper surface and a lower surface, the lower surface facing the surface of the receiving station;
capturing image information from an area of the receiving station using one or more image devices to identify a position and orientation of the second component;
attaching the upper surface of the second component to the external surface of the first component by moving the arm of the multi-axis robot from a first position, in which the first component is spaced apart from the second component, to a second position, in which the external surface of the first component is in contact with the upper surface of the second component; and
moving the first component away from the receiving station with the second component attached to the external surface of the first component.

13. The method of claim 12, further comprising directing heat and/or radiation at a bonding material on the upper surface of the second component using a heating system.

14. The method of claim 13, wherein the heating system is configured to adjust the intensity of heat or radiation based on the material properties of the bonding material.

15. The method of claim 12, wherein the image devices include a high-resolution camera for precise identification of the second component's position and orientation.

16. The method of claim 12, wherein the support structure is adjustable to accommodate different sizes and shapes of the first component.

17. The method of claim 12, wherein the support structure is a last and the first component is a component of an article of footwear.

18. The method of claim 17, wherein the support structure is a last and the first component is an upper.

19. The method of claim 17, wherein the support structure is a last and the first component is an article of footwear.

20. The method of claim 12, wherein the second component is pre-treated with a bonding agent to enhance adhesion to the first component.
